(19) United States
(12) Patent Application Publication
(10) Pub. No.: US 2006/0252550 A1
(43) Pub. Date: Nov. 9, 2006

(54) Server and gaming machine

(75) Inventor: Kazuo Okada, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP.

(21) Appl. No.: 11/408,157

(22) Filed: Apr. 21, 2006

(30) Foreign Application Priority Data
Apr. 22, 2005 (JP) 2005-125488
Apr. 22, 2005 (JP) 2005-125489

(51) Int. Cl. A63F 13/00

(52) U.S. Cl. 463/43

(57) ABSTRACT

To provide a gaming machine which can increase the range of interest of a game on the gaming machine on which the game is performed using a figure, which can arouse a desire to start performing the game on the gaming machine, and which can achieve a development of a game which is not executed on the gaming machine. A gaming machine capable of executing a game using a readable object, is configured to include: an identification information reading module which reads identification information stored in the readable object; a game execution module which executes a game; a parameter reading module which reads variable parameter information of the readable object, which varies based on the history of a game which has different contents from the game executed by the game execution module, and which is not executed on the gaming machine; and a process execution module which executes a process appropriate to the identification information read by the identification information reading module and the variable parameter information read by the parameter reading module.

### RELATED APPLICATION

This application is based upon and claims the priorities from a prior Japanese Patent Application No. 2005-125488, filed on Apr. 22, 2005 in Japan and a prior Japanese Patent Application No. 2005-125489 filed on Apr. 22, 2005 in Japan, entire contents of which are incorporated herein by reference.

### BACKGROUND OF THE INVENTION

1. Technical Field

The present invention relates to a gaming machine capable of executing a game using a server and a readable object.

2. Related Art

Until now, a trading card and a figure and the like have represented a sports player and a cartoon character and the like, and have been collected by an enthusiast, but in recent years, a game has been presented which is performed using this kind of trading card and figure and the like, and has acquired a support from a wide range of ages. A cause of a popularity of this kind of game lies in the fact that it has a double faceted advantage of a collecting aspect in collecting the trading cards and figures and the like, and an interest as a game. Recently, the trading cards and figures and the like have been given a function of a storage medium including data related to a character which appears in a game wherein, as a gaming apparatus which reads data from the storage medium and plays a video game based thereon has also appeared, it has become widely commonplace (for example, refer to Patent Documents 1 to 4: Registered Utility Model No. 3054694 and Japanese Unexamined Patent Publication Nos. 2001-096078, 2001-300138 and 2002-325972).

According to a gaming apparatus described in Patent Document 1, when a shaped article such as a weapon is connected to the gaming apparatus, the gaming apparatus reads an identification information electrically stored inside the shaped article, enabling the weapon and the like to be reflected in a game image. Also, according to a gaming apparatus described in Patent Document 2, it is possible to have it function in such a way that, by connecting a figure having the form of a character such as a dog to the gaming apparatus, and transmitting electronic data related to a game currently in progress from the gaming apparatus to the figure, the receiving figure will demonstrate a physical response such as producing a sound. Also, according to a gaming apparatus described in Patent Document 3, by connecting a figure, configured integrally with a memory card, to a memory card slot in the gaming machine, it is possible to cause the figure to move in accordance with time, an ambient temperature, light, game related data and the like. Also, according to a gaming apparatus described in Patent Document 4, it is possible to carry out a game by connecting an RFID (radio frequency ID) reader/writer to the gaming apparatus, and moving one or a plurality of RFID data carriers having a form modeled on a character in and out of a communication area of the RFID communication device in accordance with a stage of the game.

With this kind of gaming apparatus, as the figures move and the data related to the figures are reflected in the game, it is possible to generate an interest in the game.

However, in the case of the gaming apparatus in Patent Documents 1 to 4, the figures are used in a relevant game to make the game more interesting for the player, and have not generally been used when performing other games. For this reason, for example, in the event that the player becomes bored with the game, as the data and the like related to the figures acquired in the game is not generally used in other games, it is not possible to correlate etc. a plurality of games, meaning that it has been difficult to achieve game development.

Until now, however, in the case of a gaming machine equipped with a selection function such as a slot machine, in a game in which a playing medium such as a medal is paid out in the event that symbols depicted on a mechanical reel, or card symbols on reel bands expressed by an image are displayed in a prescribed combination, it is often the case that an alerting effect is added wherein a prediction related to the combination is output via a display, a speaker or the like. However, in recent years, as such an alerting effect has become used in almost all gaming machines, there has been a problem of the novelty effect starting to wear off.

As a gaming machine to solve this kind of problem, there is one on which a game is performed using a figure which the player separately purchases or the like. In the case of this gaming machine, it is possible to perform a game wherein variable parameters registered and updated in a rewritable form in the figure are reflected in a character which appears on a screen. However, in the case of this gaming machine, although there is the novelty factor of reflecting the variable parameters in the character which appears on the screen, it is necessary to perform the game in order to change the variable parameters meaning that, as it is not possible to change the variable parameters unless the game is performed, there is a danger of a reduction in a potential for arousing an interest in rearing the character. Also, in the case of this gaming machine, although by performing the game on the gaming machine, the figure improves in a non-visible way and participates in the game, as it can be predicted that the player who spends a large amount of performing the game will obtain a greater profit, the problem has existed wherein it is difficult to arouse a desire in a new player to start performing on the gaming machine.

### SUMMARY OF THE INVENTION

The invention has been made bearing in mind the heretofore described problems, and an object of the invention is to provide a gaming machine which can increase the range of interest of a game on the gaming machine on which the game is performed using the figure, which can arouse a desire to start performing the game on the gaming machine, and which can achieve a development of a game which is not executed on the gaming machine.

In order to achieve an object such as the above, there is provided a server communicating with a gaming machine comprising: a game execution module which executes a game on the web; an identification information storage module which stores identification information of a readable object; a parameter information storage module which stores variable parameter information, correlating it to the identification information; an update module which updates the variable parameter information stored in the parameter information storage module in accordance with a result of a game executed by the game execution module; and a transmitting module which transmits the variable parameter information corresponding to the identification information of the readable object received from a gaming machine to the gaming machine.

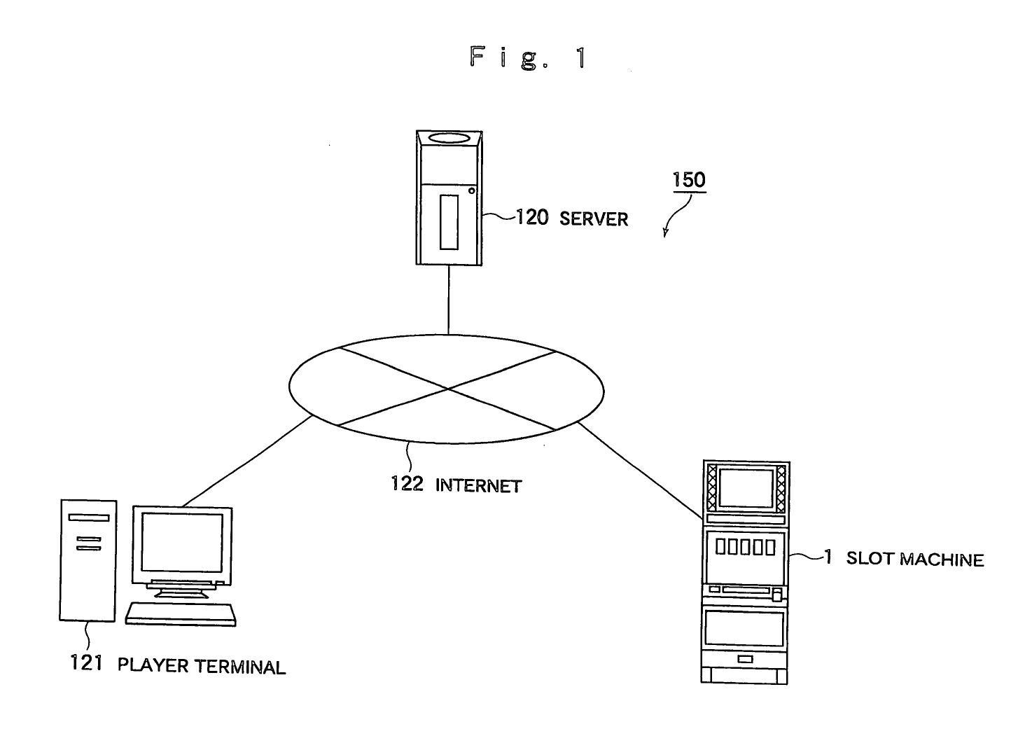

Accordingly, the variable parameter information (for example, various performance values and the like correlated to the readable object) is stored correlated to the identification information (for example, a FIG. 1D) of the readable object (for example, a figure etc.), and the variable parameter information is updated in accordance with a result of a game (for example, a horse racing game) executed on the web. Then, when the identification information of the readable object is received from the gaming machine, the variable parameter information corresponding to the identification information is transmitted to the gaming machine.

In this way, when a history (the variable parameter information) of the game executed on the web is transmitted to the gaming machine, the game is performed on the gaming machine based on the received variable parameter information. Consequently, as the history of the game executed on the web can be reflected in the game performed on the gaming machine, it is possible for the game on the web and the game on the gaming machine to have a synergetic development potential.

Also, there is provided a gaming machine capable of executing a game using a readable object comprising: an identification information reading module which reads identification information stored in the readable object; a game execution module which executes a game; a parameter reading module which reads variable parameter information of the readable object, which varies based on the history of a game which has different contents from the game executed by the game execution module, and which is not executed on the gaming machine; and a process execution module which executes a process appropriate to the identification information read by the identification information reading module and the variable parameter information read by the parameter reading module.

Accordingly, the variable parameter information (for example, the various performance values and the like correlated to the readable object) of the readable object (for example, the figure), which varies based on the history of the games which are not executed on the gaming machine (for example, games performed on the web and so-called stand alone games which are not connected to the network etc.) is read by the parameter reading module. Then, the process is carried out which is appropriate to the identification information (for example, the FIG. 1D) of the readable object read by an identification information reading module such as an IC chip reader, and the variable parameter information read by the parameter reading module.

That is, for example, in the case of a configuration wherein a server etc. stores the variable parameter information, the process is carried out which is appropriate to the identification information and the variable parameter information read from the server by the parameter reading module (for example, the CPU of the gaming machine). Also, for example, in the case of a configuration wherein the variable parameter information is stored in a storage medium (for example, an IC chip) included in the readable object, the process is carried out which is appropriate to the identification information and the variable parameter information read from the storage medium by the parameter reading module (for example, the IC chip reader).

In this way, the process is carried out which is appropriate to the identification information and the variable parameter information which varies based on the games which are not executed on the gaming machine. Therefore, for example, in the event that the player causes the variable parameter information to change by performing the games which are not executed on the gaming machine, the process (an enjoyment of privileges in the gaming machine etc.), which is appropriate to the variable parameter information changed in the game, can be carried out in the gaming machine. Consequently, the history of the game not executed on the gaming machine can be related to the game on the gaming machine, thus increasing the interest value of the game.

Also, as the history of the game not executed on the gaming machine is related to the game on the gaming machine, it is possible to give people who do not normally perform games on the gaming machine the desire to do so.

Furthermore, as the variable parameter information used in a game not executed on the gaming machine can be used in a game executed on the gaming machine other than the game, the variable parameter information can be used in a wide variety of games and the like, making it possible to achieve game development.

According to the invention, a gaming machine can be provided wherein the enjoyment of a gaming machine on which a game is performed using a figure can be increased and, the desire to perform a new game on the gaming machine can be imparted and, furthermore, the development of a game which is not executed on the gaming machine can be achieved.

Additional objects and advantage of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

FIG. 1 is a network configuration diagram showing one example of a game system according to an embodiment;

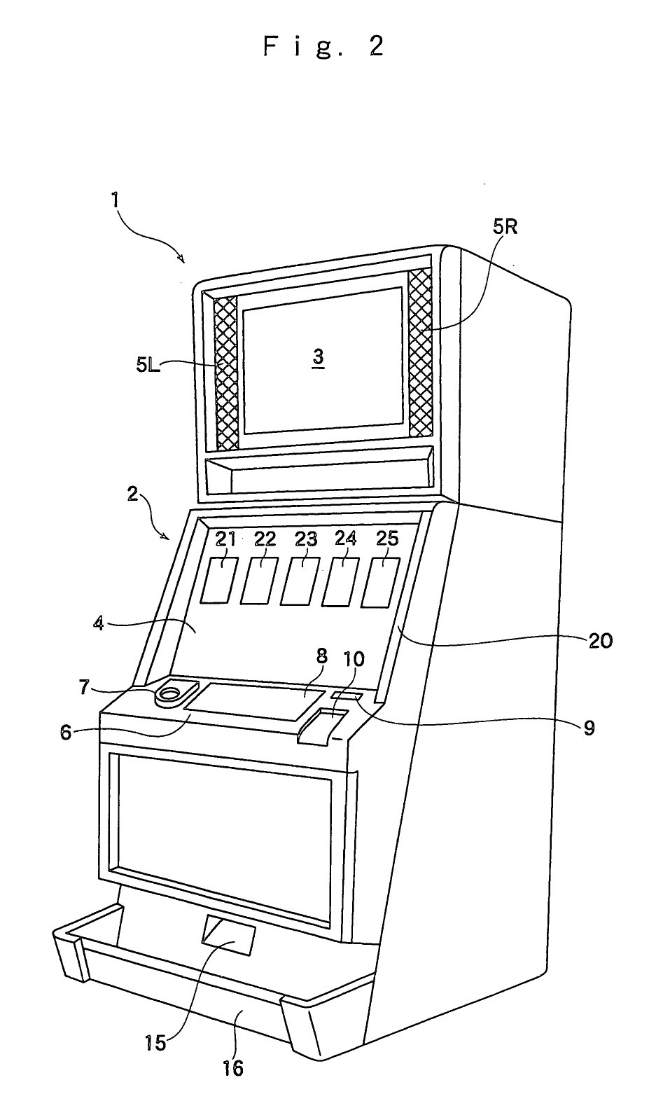

FIG. 2 is a perspective view showing an external appearance of a slot machine shown in FIG. 1;

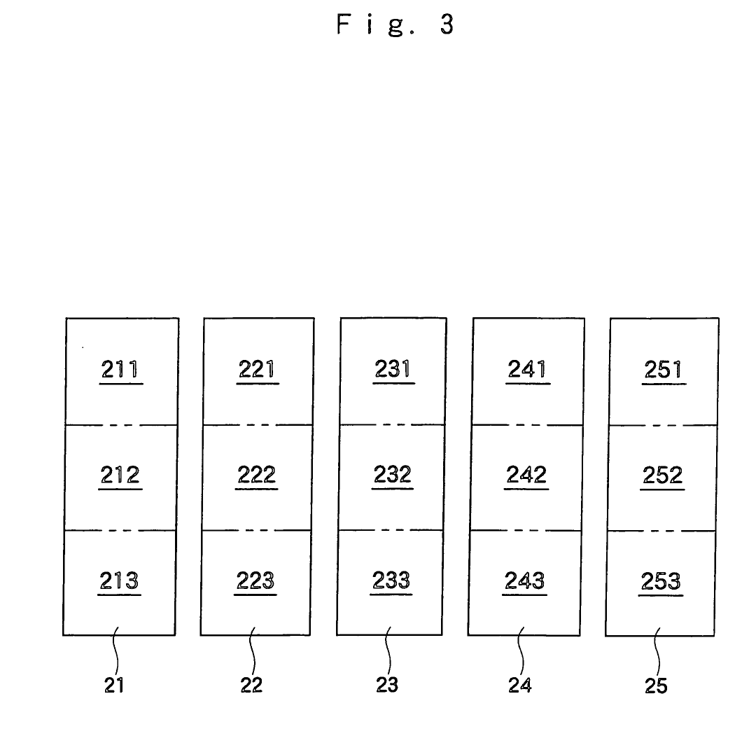

FIG. 3 is a front view showing variable display windows of the slot machine shown in FIG. 1;

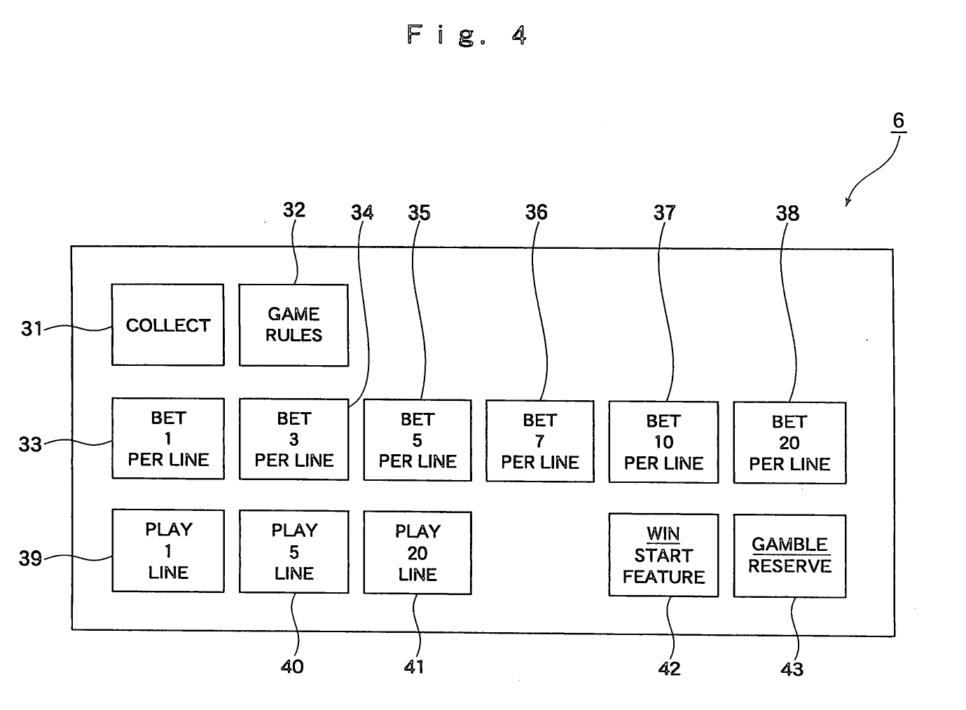

FIG. 4 is a front view showing an operating table of the slot machine shown in FIG. 1;

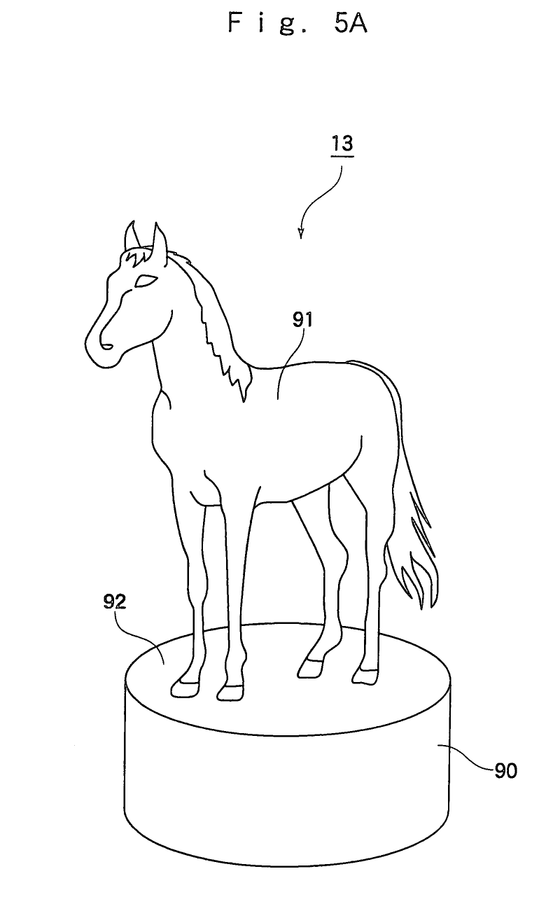

FIGS. 5A and 5B are front views showing a figure used in the slot machine shown in FIG. 1;

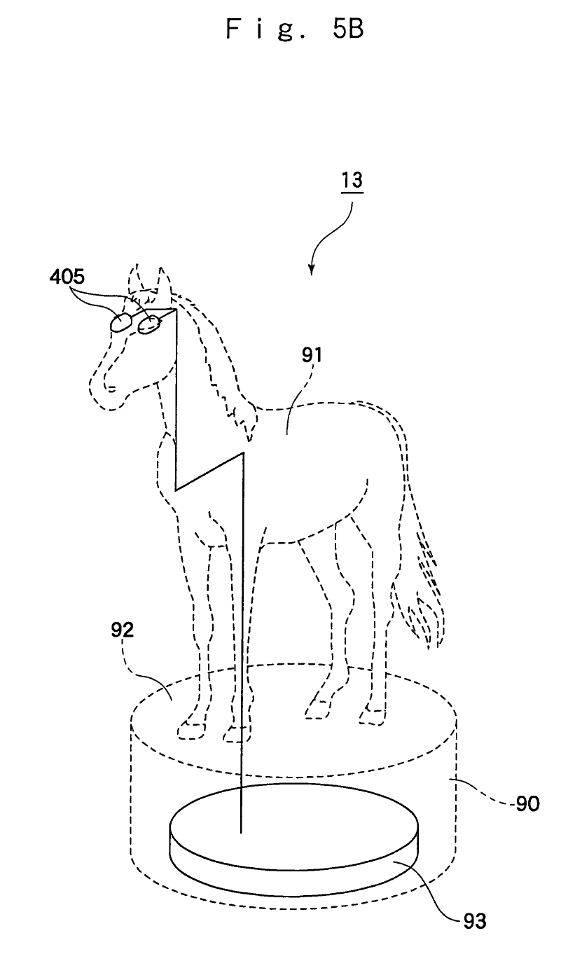

FIG. 6 is a block diagram showing an internal configuration of an IC tag;

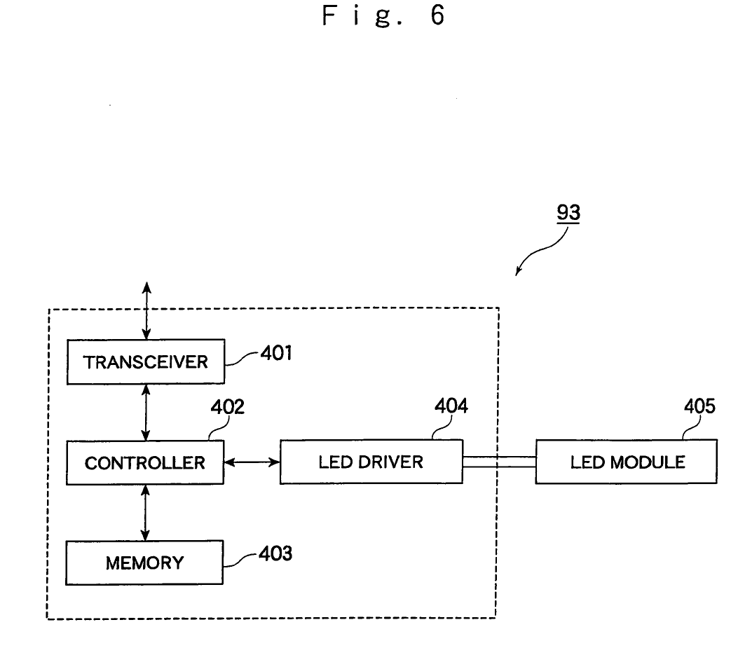

FIG. 7 is an exploded perspective view showing an authentication unit provided in the slot machine shown in FIG. 1;

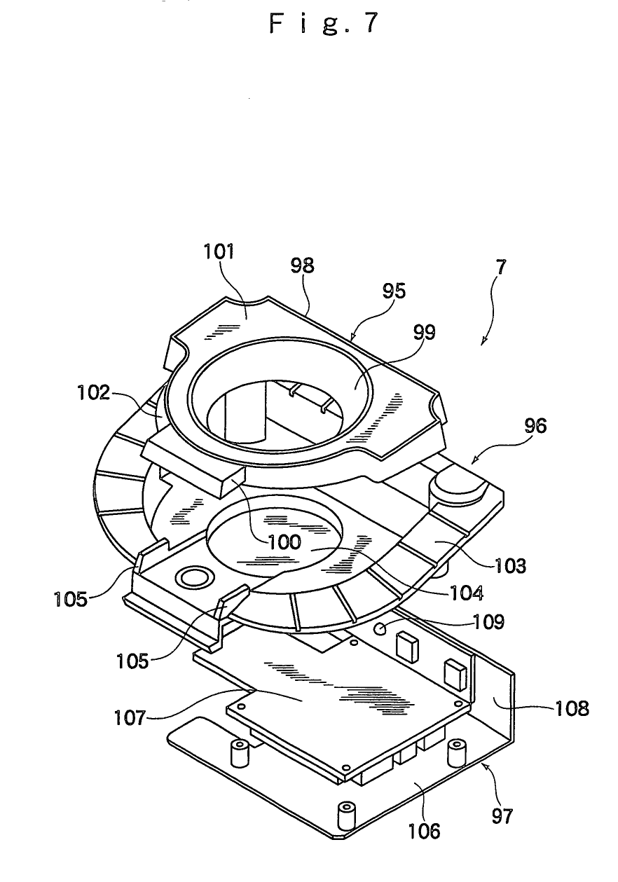

FIG. 8 is a front view showing the authentication unit on which a figure is mounted;

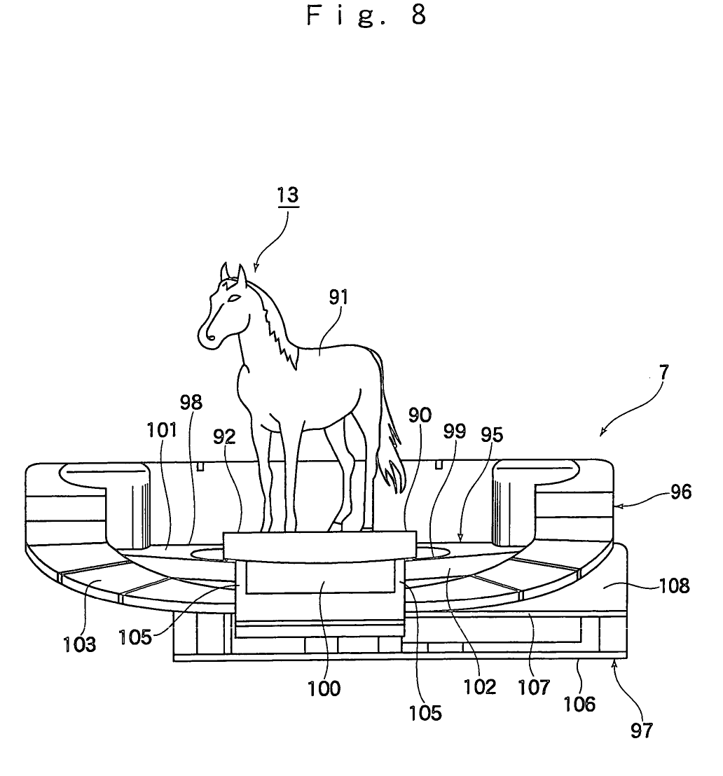

FIG. 9 is a schematic diagram showing an example of symbols variably displayed in the variable display windows by a first reel band to a fifth reel band;

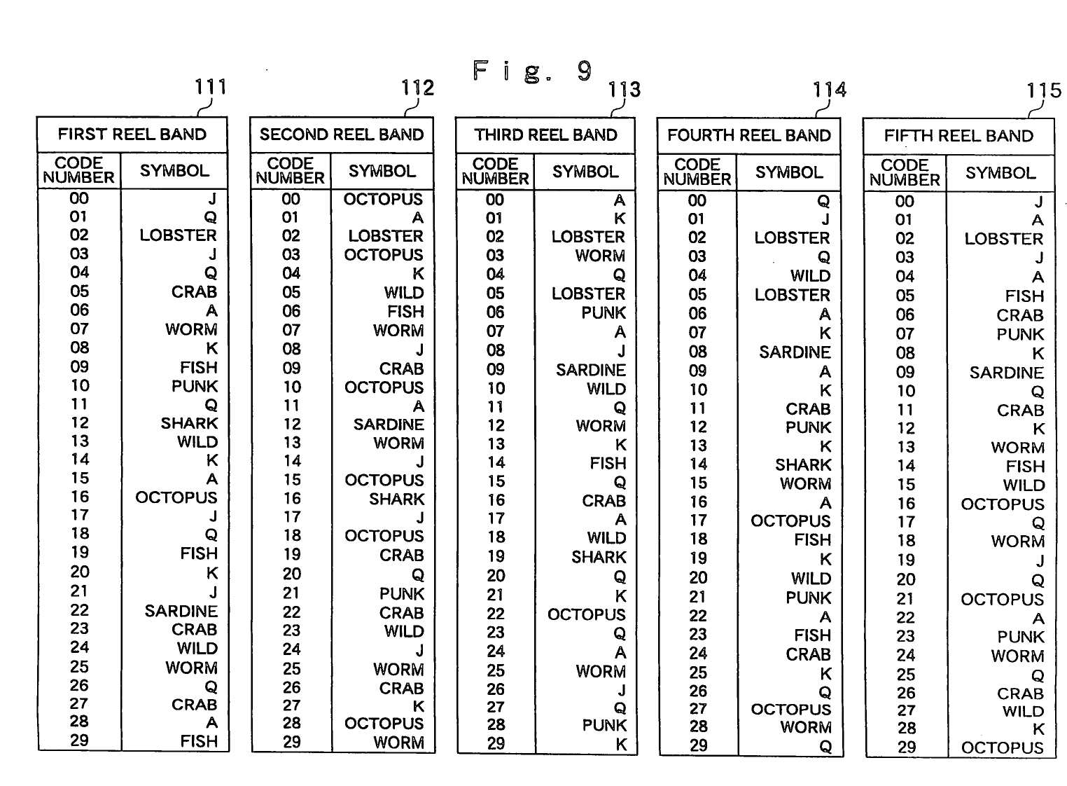

FIG. 10 is a block diagram schematically showing a control system of the slot machine;

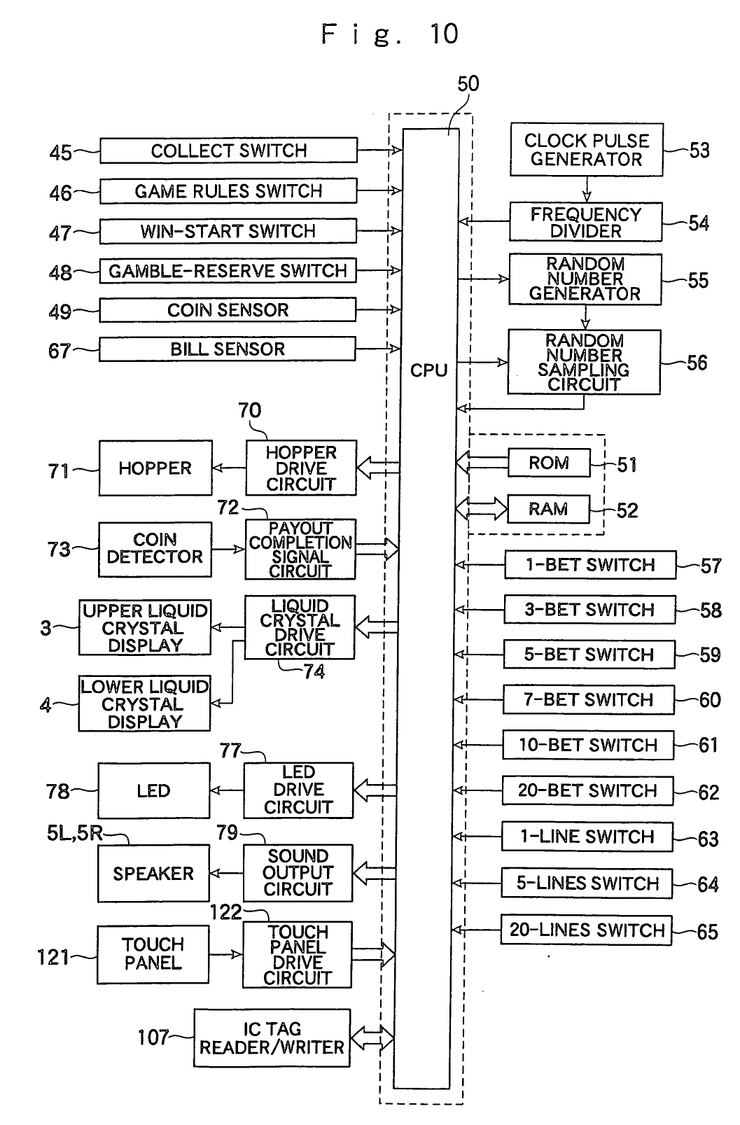

FIG. 11 is a block diagram schematically showing a liquid crystal drive circuit of a liquid crystal display;

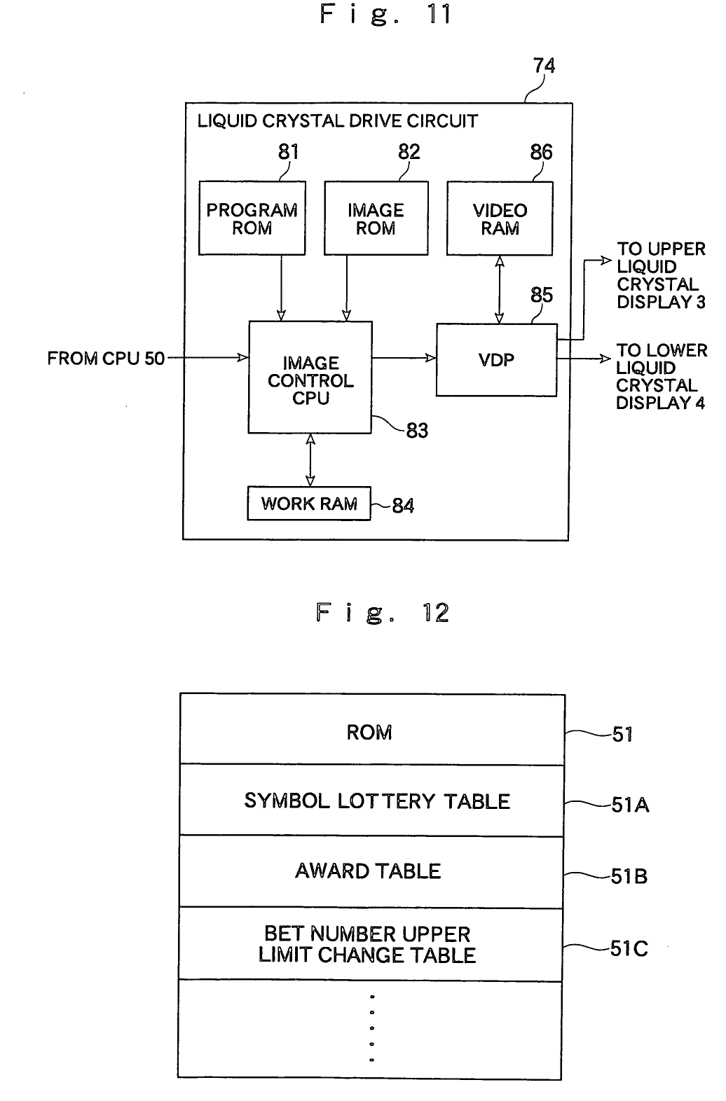

FIG. 12 is a diagram showing each storage area of an ROM of the slot machine;

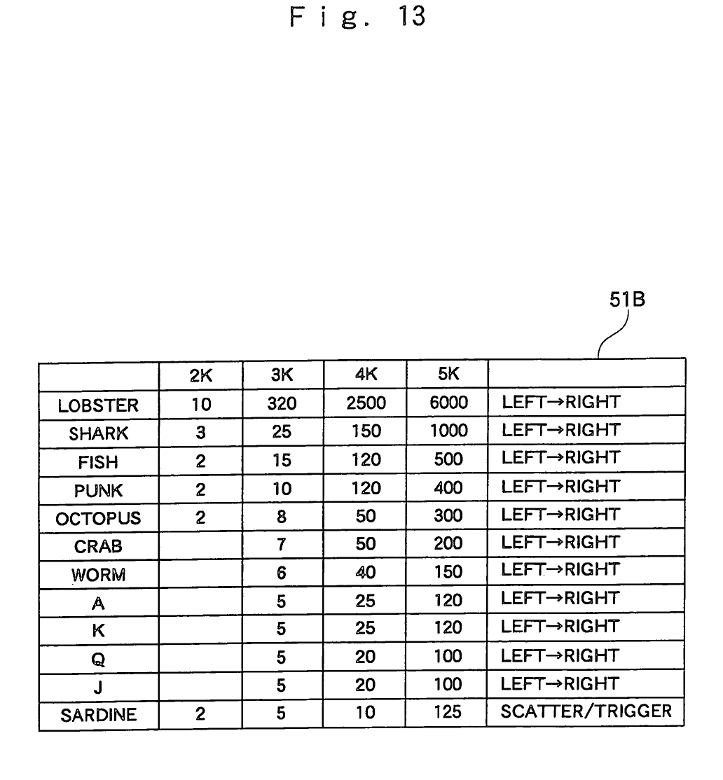

FIG. 13 is a diagram showing an award table showing winning combinations and awards thereof;

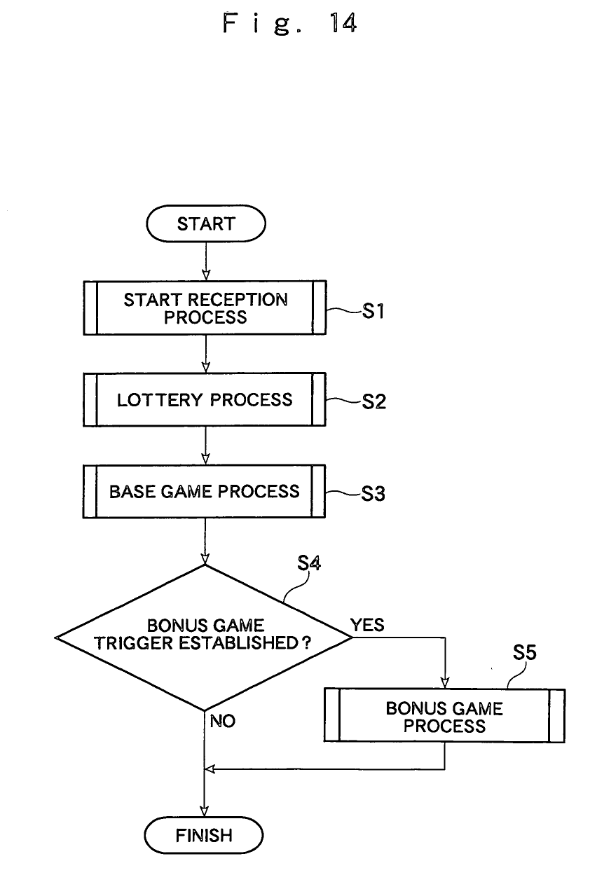

FIG. 14 is a flowchart of a main process program of the slot machine;

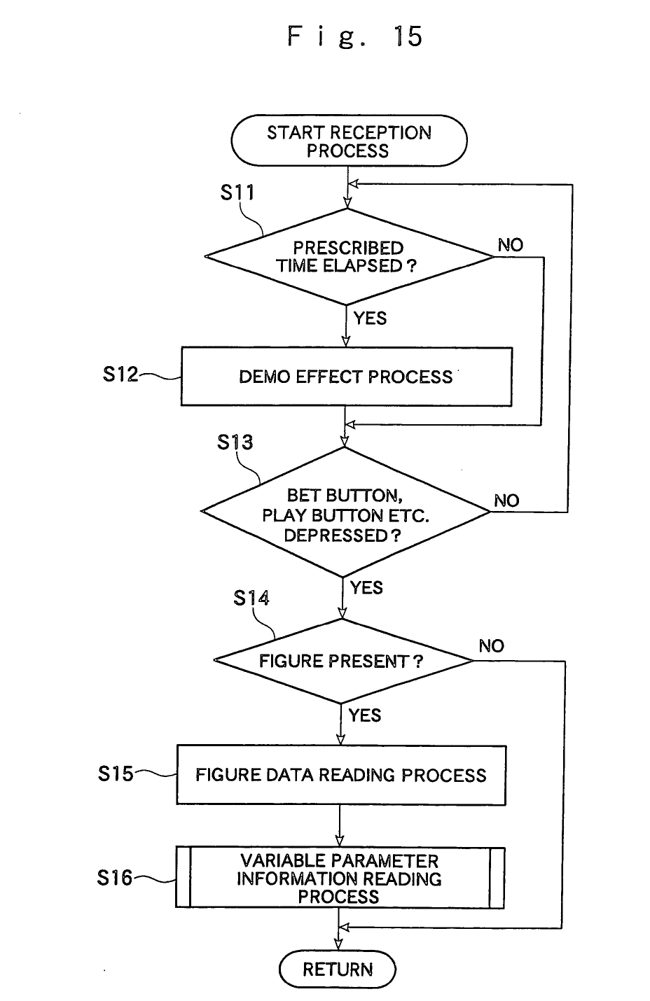

FIG. 15 is a flowchart of a start reception process program of the slot machine;

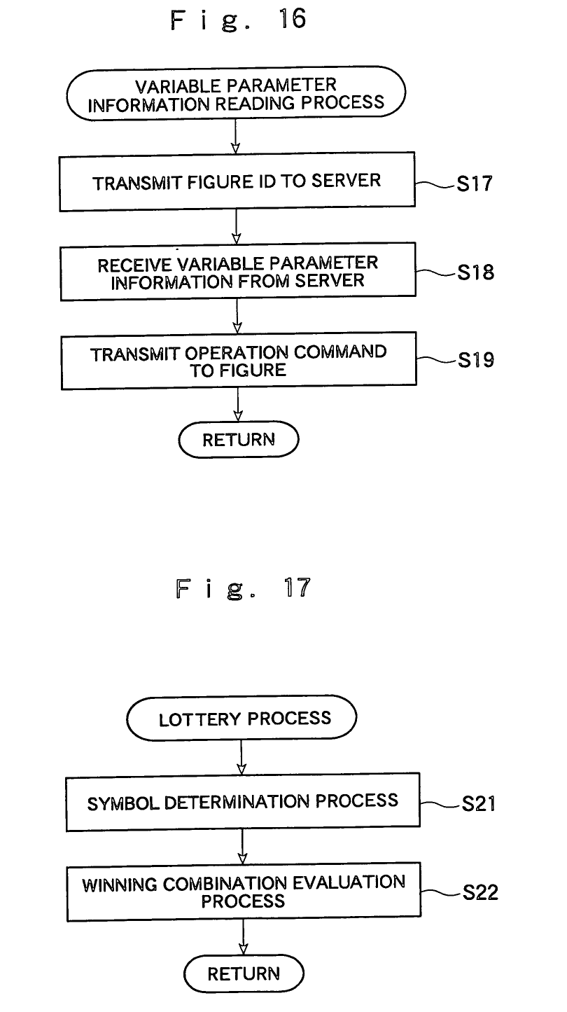

FIG. 16 is a flowchart of a variable parameter information reading process program of the slot machine;

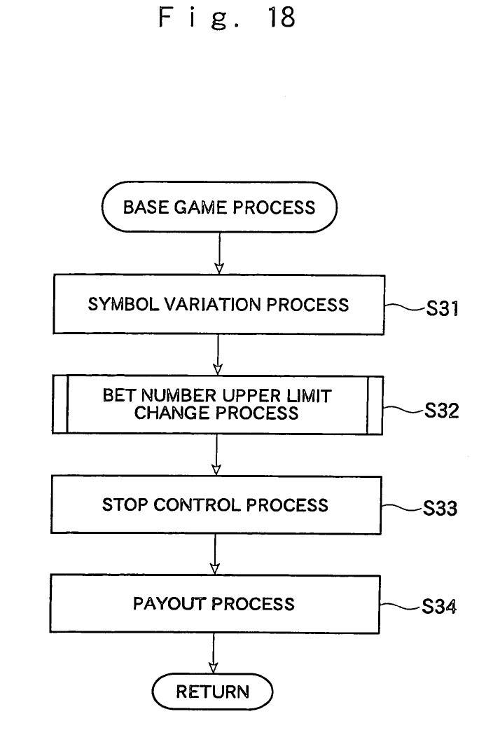

FIG. 17 is a flowchart of a lottery process program of the slot machine;

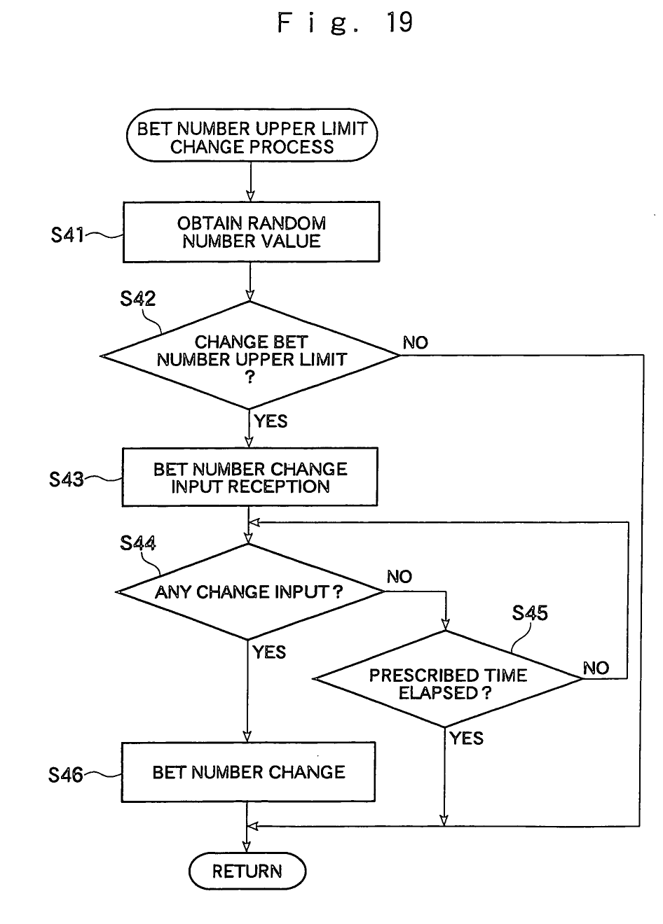

FIG. 18 is a flowchart of a base game process program of the slot machine;

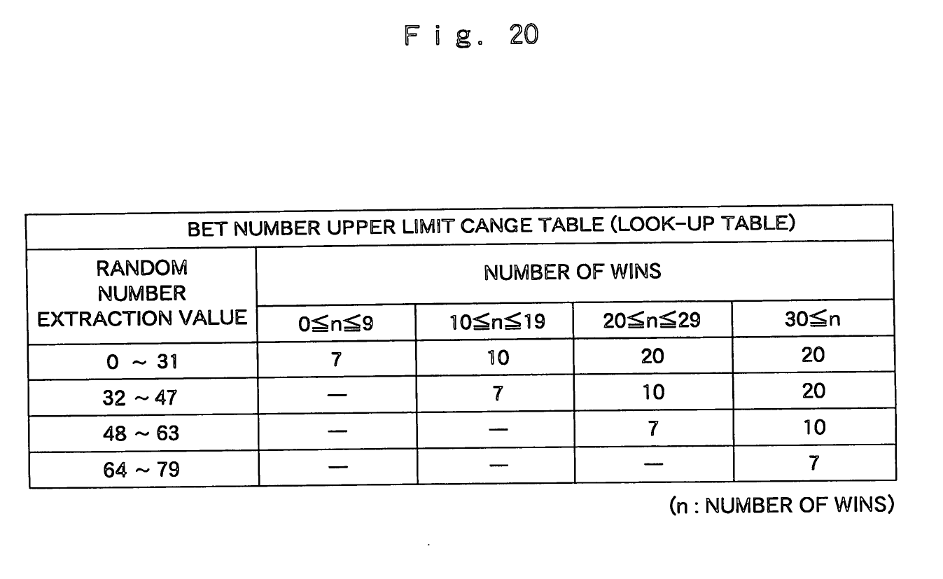

FIG. 19 is a flowchart of a bet number upper limit change process program of the slot machine;

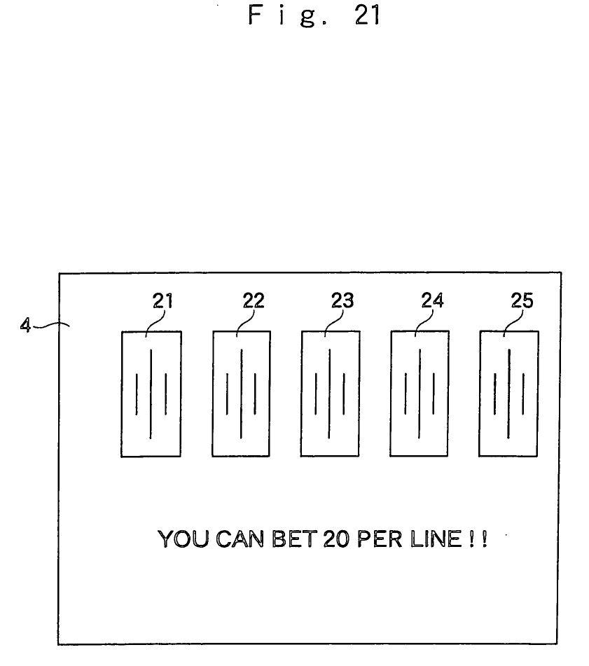

FIG. 20 is a diagram showing one example of a bet number upper limit change table;

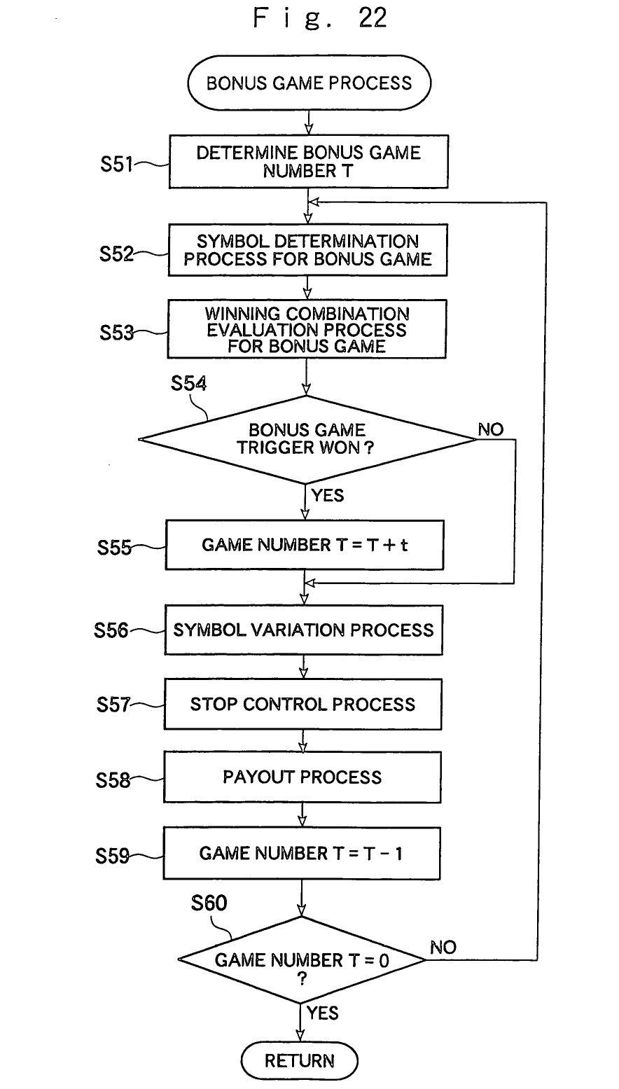

FIG. 21 is a front view showing an image displayed on a lower liquid crystal display;

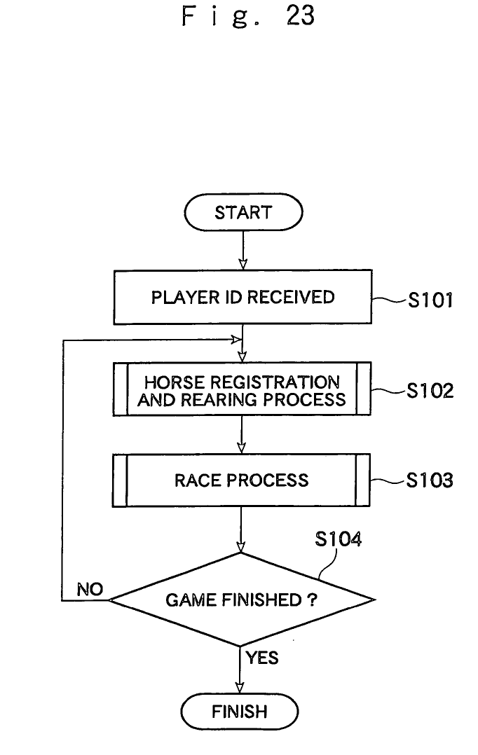

FIG. 22 is a flowchart of a bonus game process program in the slot machine;

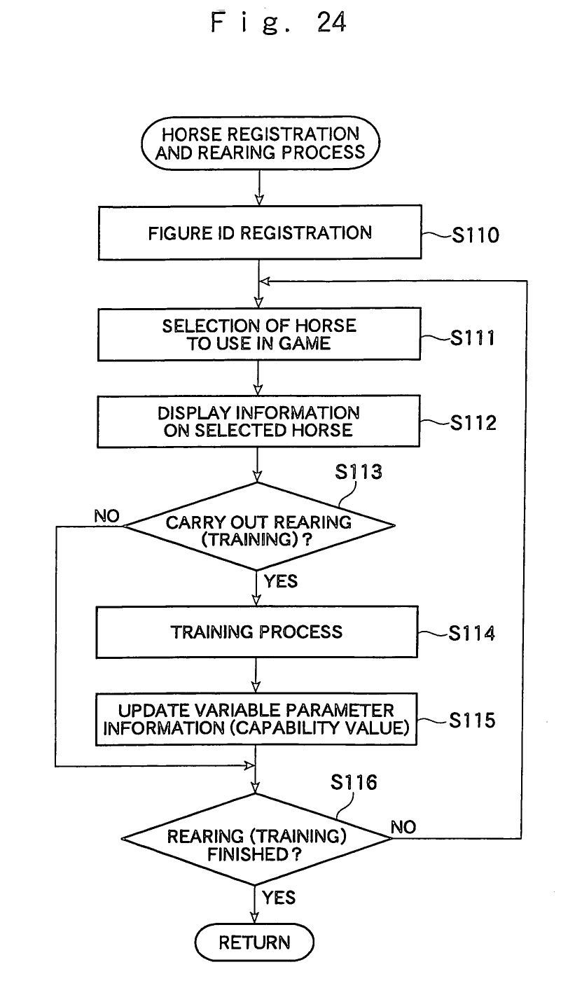

FIG. 23 is a flowchart of a main process program of a horse racing game carried out on a server;

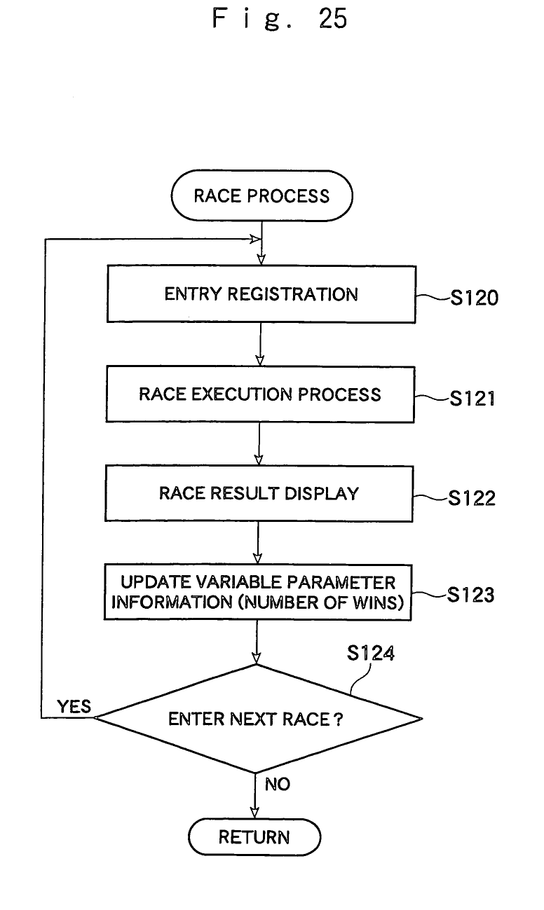

FIG. 24 is a flowchart of a horse registration and rearing program of the horse racing game carried out on the server;

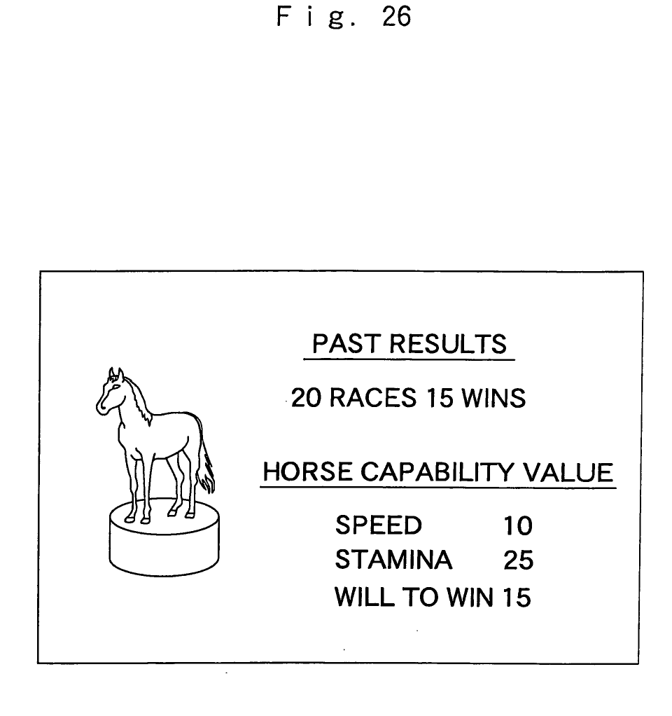

FIG. 25 is a flowchart of a race process program of the horse racing game carried out on the server;

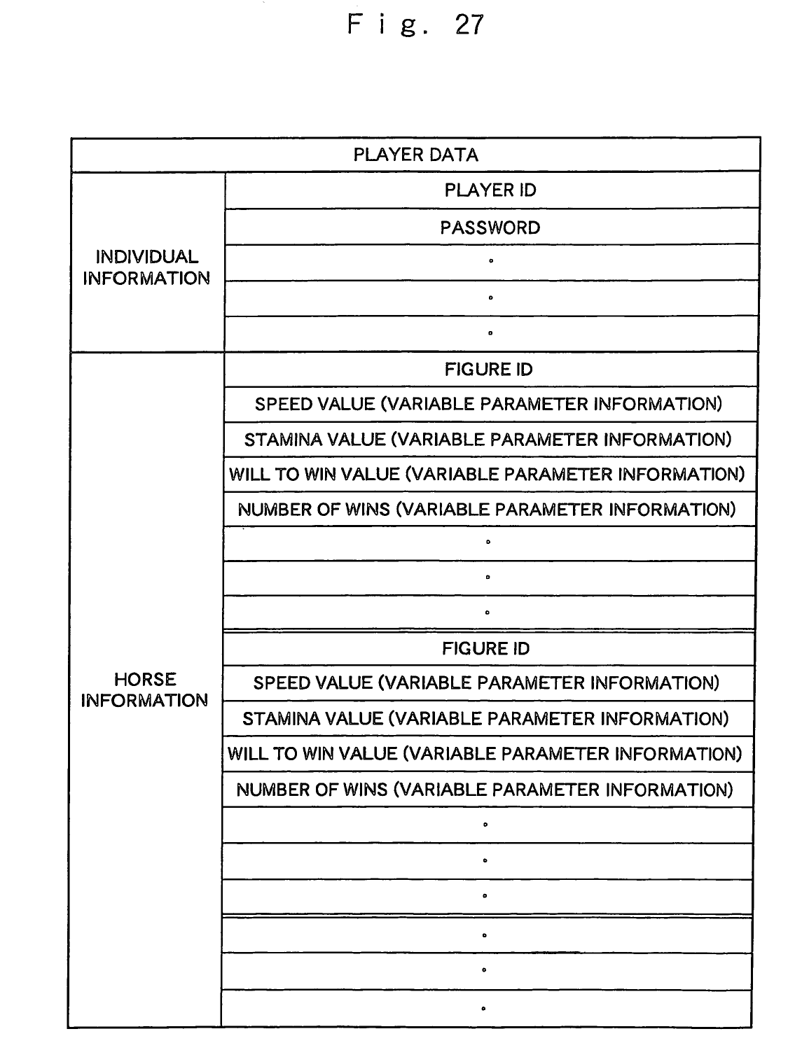

FIG. 26 is a diagram showing one example of a screen image displayed on a player terminal;

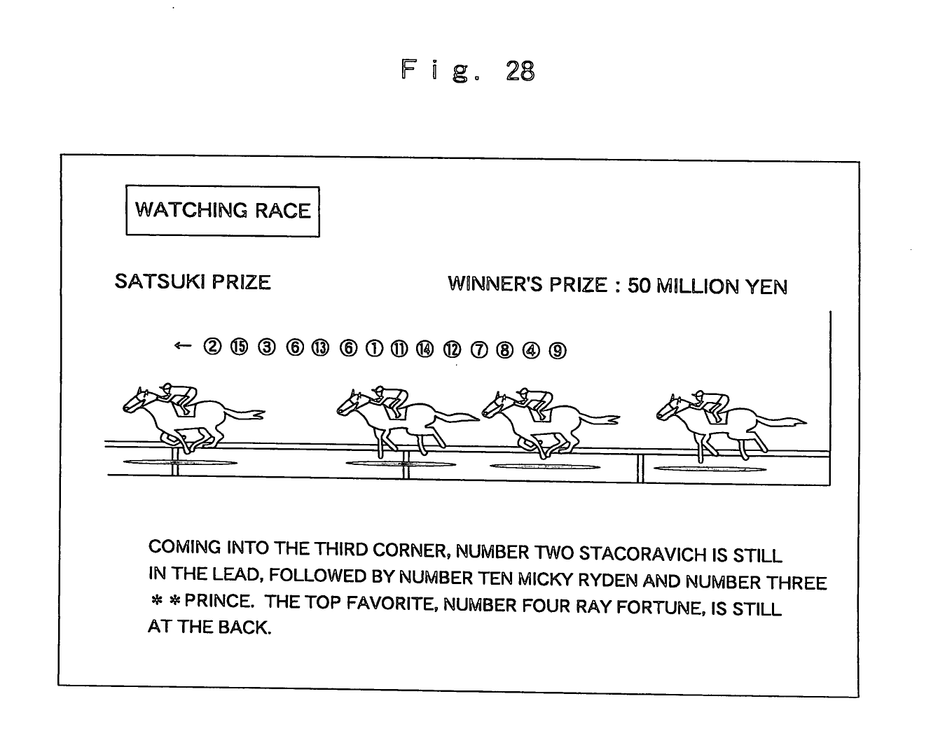

FIG. 27 is a diagram showing one example of player data;

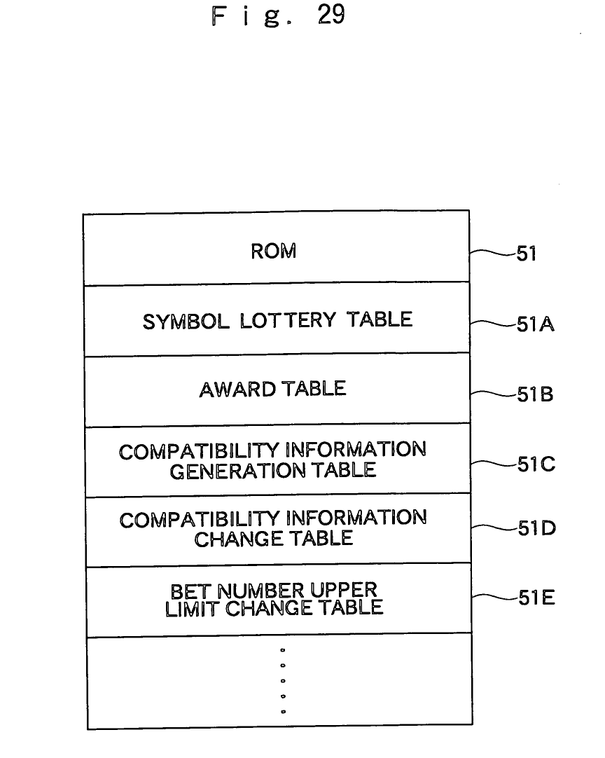

FIG. 28 is a diagram showing one example of the screen image displayed on the player terminal;

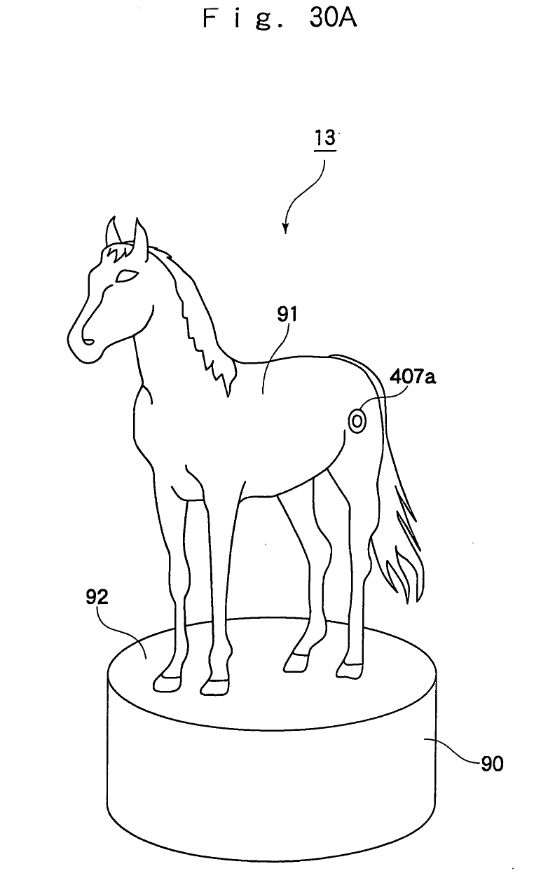

FIG. 29 is a diagram showing each storage area of a ROM of a slot machine;

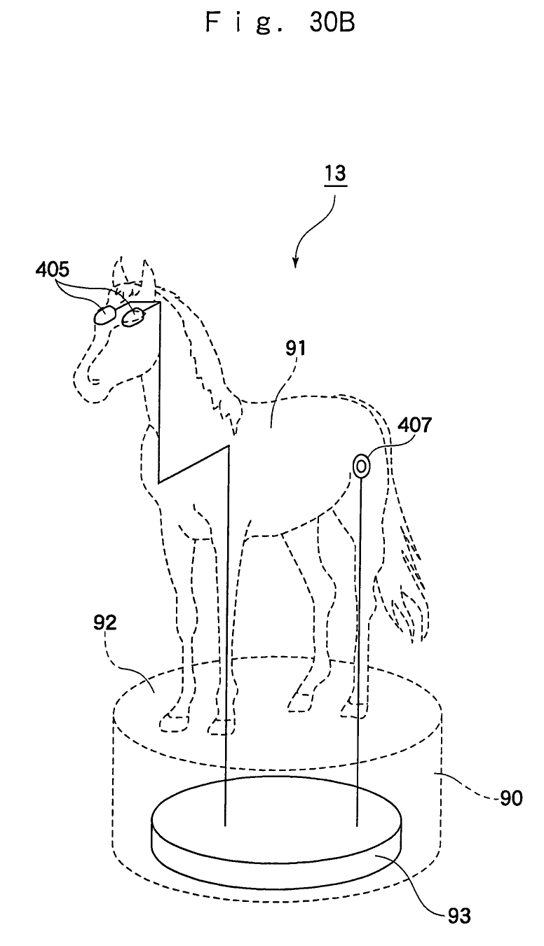

FIGS. 30A and 30B are front views showing a figure used in the slot machine shown in FIG. 1;

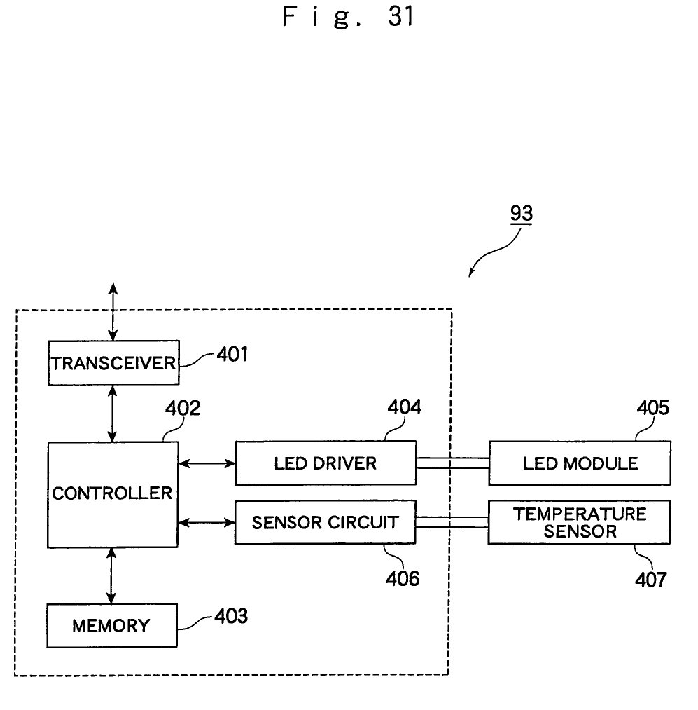

FIG. 31 is a block diagram showing an internal configuration of an IC tag;

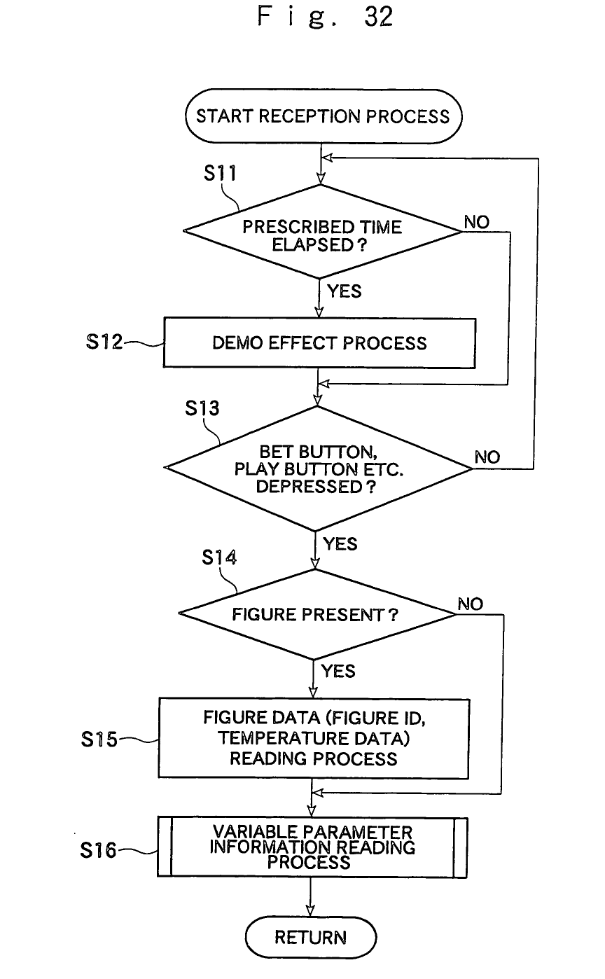

FIG. 32 is a flowchart of a start reception process program of the slot machine;

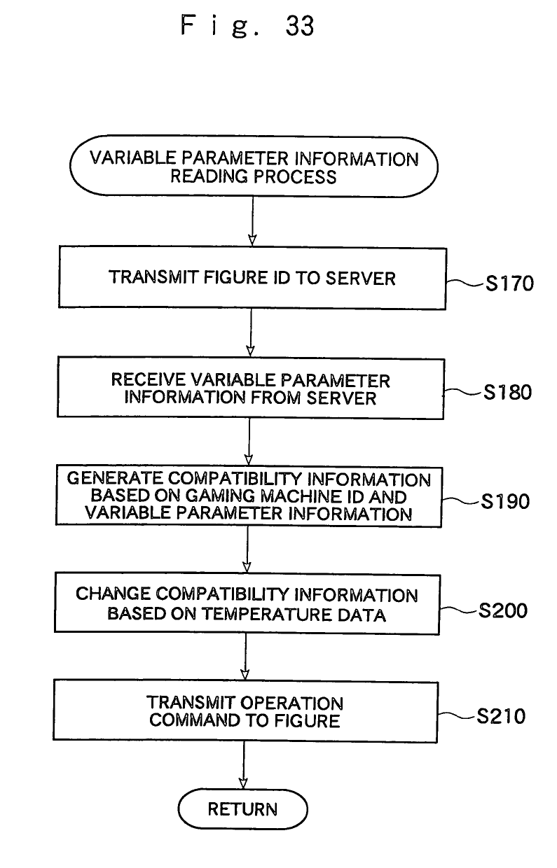

FIG. 33 is a flowchart of a variable parameter information reading process program of the slot machine;

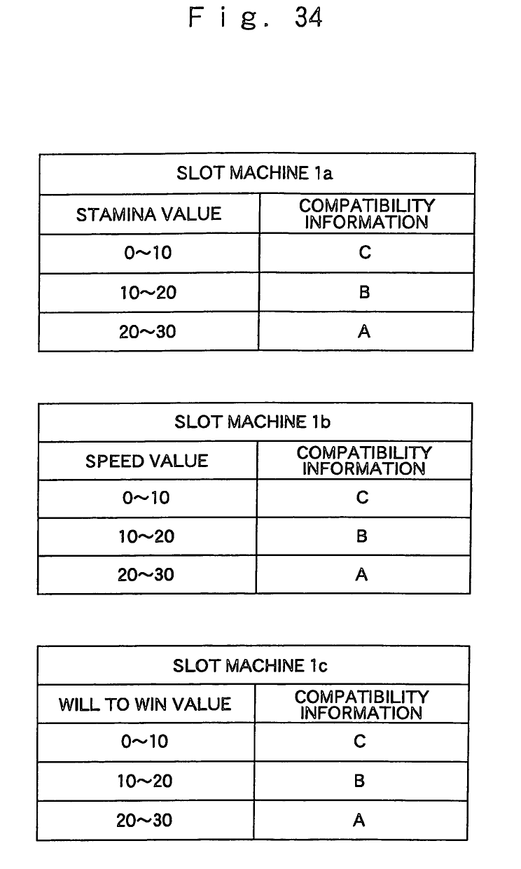

FIG. 34 is a diagram showing one example of a compatibility information generation table;

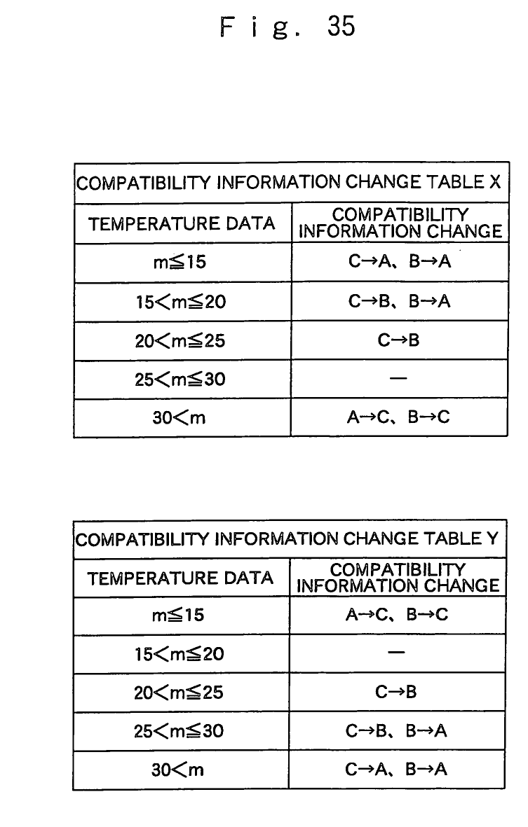

FIG. 35 is a diagram showing one example of a compatibility information change table; and

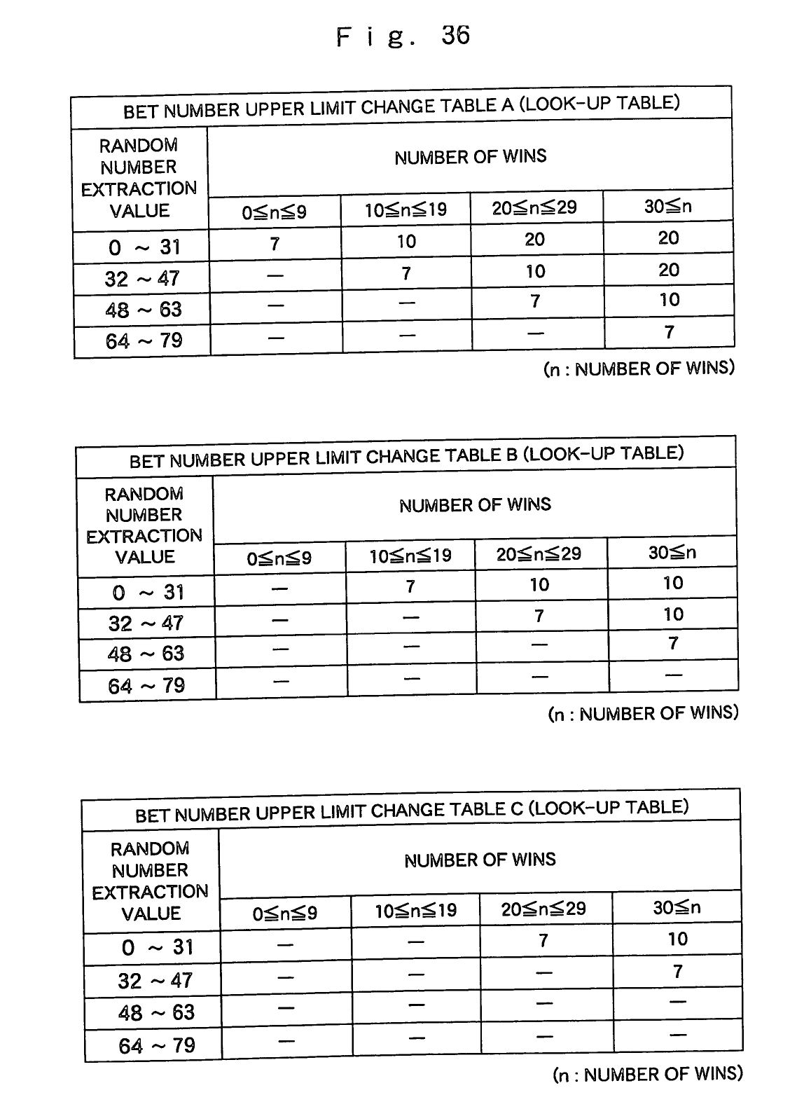

FIG. 36 is a diagram showing one example of a bet number upper limit change table.

### DESCRIPTION OF THE PREFERRED EMBODIMENT(S)

According to a first aspect of the invention, there is provided a server communicating with a gaming machine of this embodiment comprising: a game execution module which executes a game on the web; an identification information storage module which stores identification information of a readable object; a parameter information storage module which stores variable parameter information, correlating it to the identification information; an update module which updates the variable parameter information stored in the parameter information storage module in accordance with a result of a game executed by the game execution module; and a transmitting module which transmits the variable parameter information corresponding to the identification information of the readable object received from a gaming machine to the gaming machine.

Accordingly, the variable parameter information (for example, various performance values and the like correlated to the readable object) is stored correlated to the identification information (for example, a FIG. 1D) of the readable object (for example, a figure etc.), and the variable parameter information is updated in accordance with a result of a game (for example, a horse racing game) executed on the web. Then, when the identification information of the readable object is received from the gaming machine, the variable parameter information corresponding to the identification information is transmitted to the gaming machine.

In this way, when a history (the variable parameter information) of the game executed on the web is transmitted to the gaming machine, the game is performed on the gaming machine based on the received variable parameter information. Consequently, as the history of the game executed on the web can be reflected in the game performed on the gaming machine, it is possible for the game on the web and the game on the gaming machine to have a synergetic development potential.

Executing a game on the web refers to the executing of a game by connecting computers via a wireless or wired communication network, and carrying out a transmission and reception of game input data and game result data between the computers.

According to a second aspect of the invention, in the server communicating with a gaming machine, the variable parameter information transmitted to the gaming machine from the transmitting module is used as information for the purpose of generating compatibility information correlated to the identification information of the readable object received from the gaming machine.

Accordingly, when the identification information of the readable object is received from the gaming machine, the variable parameter information is transmitted to the gaming machine for the purpose of generating compatibility information correlated to the identification information.

In this way, when a history (the variable parameter information) of the game executed on the web is transmitted to the gaming machine, compatibility information based on the received variable parameter information is generated, and the game is performed on the gaming machine based on the compatibility information.

Consequently, in this invention as well, as the history of the game executed on the web can be reflected in the game performed on the gaming machine, it is possible for the game executed on the web and the game performed on the gaming machine to have a synergetic development potential.

According to a third aspect of the invention, there is provided a gaming machine capable of executing a game using a readable object of this embodiment comprising: an identification information reading module which reads identification information stored in the readable object; a game execution module which executes a game; a parameter reading module which reads variable parameter information of the readable object, which varies based on the history of a game which has different contents from the game executed by the game execution module, and which is not executed on the gaming machine; and a process execution module which executes a process appropriate to the identification information read by the identification information reading module and the variable parameter information read by the parameter reading module.

Accordingly, the variable parameter information (for example, the various performance values and the like correlated to the readable object) of the readable object (for example, the figure), which varies based on the history of the games which are not executed on the gaming machine (for example, games performed on the web and so-called stand alone games which are not connected to the network etc.) is read by the parameter reading module. Then, the process is carried out which is appropriate to the identification information (for example, the FIG. 1D) of the readable object read by an identification information reading module such as an IC chip reader, and the variable parameter information read by the parameter reading module.

That is, for example, in the case of a configuration wherein a server etc. stores the variable parameter information, the process is carried out which is appropriate to the identification information and the variable parameter information read from the server by the parameter reading module (for example, the CPU of the gaming machine). Also, for example, in the case of a configuration wherein the variable parameter information is stored in a storage medium (for example, an IC chip) included in the readable object, the process is carried out which is appropriate to the identification information and the variable parameter information read from the storage medium by the parameter reading module (for example, the IC chip reader).

In this way, the process is carried out which is appropriate to the identification information and the variable parameter information which varies based on the games which are not executed on the gaming machine. Therefore, for example, in the event that the player causes the variable parameter information to change by performing the games which are not executed on the gaming machine, the process (an enjoyment of privileges in the gaming machine etc.), which is appropriate to the variable parameter information changed in the game, can be carried out in the gaming machine. Consequently, the history of the game not executed on the gaming machine can be related to the game on the gaming machine, thus increasing the interest value of the game.

Also, as the history of the game not executed on the gaming machine is related to the game on the gaming machine, it is possible to give people who do not normally perform games on the gaming machine the desire to do so.

Furthermore, as the variable parameter information used in a game not executed on the gaming machine can be used in a game executed on the gaming machine other than the game, the variable parameter information can be used in a wide variety of games and the like, making it possible to achieve game development.

According to a fourth aspect of the invention, the gaming machine capable of executing a game using a readable object further comprises: an input device which enables an input of a number of playing media bet in one game, wherein the process execution module changes an upper limit of the number of playing media bet which can be input by the input device, in accordance with the variable parameter information read by the parameter reading module.

Accordingly, it is possible to change the upper limit of the number of insertable playing media (for example, medals) bet, in accordance with the variable parameter information read by the parameter reading module. Consequently, by reflecting the number of bets in the number of payouts, it is possible to arouse an appropriate gambling spirit, thereby increasing the interest value of the game.

According to a fifth aspect of the invention, the gaming machine capable of executing a game using a readable object further comprises: a controller which controls in such a way as to cause the readable object to operate in accordance with the variable parameter information read by the parameter reading module.

Accordingly, the readable object is caused to operate in accordance with the variable parameter information read by the parameter reading module. Consequently, for example, it is possible to cause the full color LED's disposed in the eye position of the figure (the readable object) to illuminate in accordance with the variable parameter information, and to cause the figure to dance in accordance with the variable parameter information. Therefore, it is possible to inform the player that the readable object is having an effect on the game on the gaming machine.

According to a sixth aspect of the invention, the gaming machine capable of executing a game using a readable object further comprises: a gaming machine information storage module which stores gaming machine information established for each gaming machine; and a compatibility information generating module, which generates compatibility information showing, according to a prescribed standard, a relationship between the gaming machine information stored in the gaming machine information storage module and the variable parameter information read by the parameter reading module, wherein the process execution module executes a process appropriate to the identification information read by the identification information reading module and the compatibility information generated by the compatibility information generating module.

Accordingly, the variable parameter information (for example, the various performance values and the like correlated to the readable object) of the readable object (for example, the figure), which varies based on the history of the games which are not executed on the gaming machine (for example, games performed on the web and so-called stand alone games which are not connected to the network etc.), is read by the parameter reading module.

That is, for example, in the case of a configuration wherein a server etc. stores the variable parameter information, the variable parameter information is read from the server by the parameter reading module (for example, the CPU of the gaming machine). Also, for example, in the case of a configuration wherein the variable parameter information is stored in a storage medium (for example, the IC chip) included in the readable object, the variable parameter information is read from the storage medium by the parameter reading module (for example, the IC chip reader).

Next, compatibility information is generated showing, according to a prescribed standard, a relationship between the gaming machine information (for example, a gaming machine ID) stored in the gaming machine information storage module (for example, a ROM included in the gaming machine) and the variable parameter information read by the parameter reading module. Then, the process is executed which is appropriate to the identification information read by the identification information reading module, such as the IC chip reader, and the generated compatibility information.

In this way, the process is carried out based on the compatibility information generated based on the gaming machine information and the variable parameter information which varies based on the games which are not executed on the gaming machine. Therefore, for example, in the event that the player causes the variable parameter information to change by performing a game which is not executed on the gaming machine, the process (for example, a process which changes a reliability of an alerting effect and a process which changes an upper limit of a number of medals bet in one game), which is appropriate to the variable parameter information changed in the game, can be carried out in the gaming machine. Consequently, the history of the game not executed on the gaming machine can be related to the game on the gaming machine, thus increasing the interest value of the game.

Also, the contents of the process executed in the gaming machine are contents based on the compatibility information which shows a relationship between the gaming machine information and the variable parameter information. Therefore, it is possible to create a difference between the process executed when the player plays the game on one gaining machine and the process executed when the player plays the game on another gaming machine. Consequently, it is possible to give the player the enjoyment of selecting which gaming machine to perform the game on.

Also, in this invention, as the history of the game not executed on the gaming machine is related to the game on the gaming machine, it is possible to give people who do not normally perform games on the gaming machine the desire to do so.

Furthermore, as the variable parameter information used in a game not executed on the gaming machine can be used in a game executed on the gaming machine other than the game, the variable parameter information can be used in a wide variety of games and the like, making it possible to achieve game development.

According to a seventh aspect of the invention, the gaming machine capable of executing a game using a readable object further comprises: an ambient data reading module which reads ambient data related to an ambient physical phenomenon detected by a sensor provided on the readable object, wherein the process execution module executes a process appropriate to the identification information read by the identification information reading module, the compatibility information generated by the compatibility information generating module, and the ambient data read by the ambient data reading module.

Accordingly, the process is executed based on the identification information, the compatibility information and the ambient data (for example, data related to the temperature and data related to the light (for example, a strength of a light of a prescribed frequency)) related to an ambient physical phenomenon detected by a sensor (for example, a temperature sensor and a light sensor) provided on the readable object. Consequently, when the contents of the process executed in the gaming machine are caused to be different in each gaming machine, it is possible to create a difference in the contents of the process based on the physical phenomena of the ambience in which the player plays the game. As a result, it is possible to give the player the enjoyment of considering the ambient physical phenomena (for example, the temperature and the amount of light) when selecting which gaming machine to perform the game on.

According to an eighth aspect of the invention, the gaming machine capable of executing a game using a readable object further comprises: a controller which controls in such a way as to cause the readable object to operate in accordance with the compatibility information generated by the compatibility information generating module.

Accordingly, the readable object is caused to operate in accordance with the compatibility information generated by the compatibility information generating module. Consequently, for example, it is possible to cause the full color LED's disposed in the eye position of the figure (the readable object) to illuminate in accordance with the variable parameter information, and to cause the figure to dance in accordance with the variable parameter information. Therefore, it is possible to inform the player that the readable object is having an effect on the game on the gaming machine.

According to a ninth aspect of the invention, in the gaming machine capable of executing a game using a readable object, the controller carries out display control on a display module included in the readable object in accordance with the compatibility information generated by the compatibility information generating module.

Accordingly, it is possible to carry out a display in a display module (for example, the LED disposed in the eye position of the figure) included in the readable object (for example, the figure) in accordance with the compatibility information generated by the compatibility information generating module. Consequently, for example, by changing a color of the display in the display module in accordance with the compatibility information, it is possible to inform the player of the compatibility.

### First Embodiment

FIG. 1 is a network configuration diagram showing one example of a game system equipped with a slot machine according to an embodiment.

The game system 150, which controls and manages a horse racing game site, comprises a server 120, which executes a horse racing game performed on the site, a player terminal 121, which can be connected to an internet 122, and a slot machine 1, which reads a FIG. 1D from a FIG. 13 (not shown) used in the game system 150.

The player terminal 121 can be connected to the server 120 via the internet 122, thereby, by using a prescribed browser, enabling access to a horse racing game site made available to the public on the Internet by the server 120. The communication of various kinds of data between the server 120 and the player terminal 121 is carried out via the internet 122. In this embodiment, a description will be given of a case in which the player terminal 121 is a general-purpose personal computer which can be connected to the server 120 via the internet 122.

The server 120 comprises a hard disc drive which stores player data (for example, a player ID for each player, the FIG. 1D for a figure which acts as a readable object belonging to each player, and variable parameter information which shows a performance value, a number of victories and the like for a horse corresponding to the figure) and the like, a CPU which controls each portion of the server 120, and a program ROM which records a program executed by the CPU. The player registers the FIG. 1D of a separately purchased figure from the player terminal 121, enabling the performance of the horse racing game with the horse shown by the figure. Although it is possible to use a general-purpose personal computer or work station as the server 120, it is also acceptable to use one part of a server professionally managed and controlled.

The slot machine 1 includes an IC tag reader/writer 107 (not shown), which enables a reading of a FIG. 1D from an IC tag 93 included in the FIG. 13. When a game is started, the slot machine 1 reads the FIG. 1D, and reads the variable parameter information of the figure corresponding to the FIG. 1D from the server 120. Based on the variable parameter information, the slot machine 1 changes a limit of a number of coins bet. Consequently, by using the figure, the player can bet a large number of medals on a game performed on the slot machine 1.

Although the slot machine according to this embodiment is a slot machine which uses a so-called video reel, it is one with which a player can, by mounting the separately purchased figure in a prescribed position in the slot machine, perform a game corresponding to the figure mounted. Firstly, a description will be given of a schematic configuration of the slot machine according to this embodiment, based on FIGS. 2 to 4. FIG. 2 is a perspective view showing an external appearance of the slot machine according to this embodiment. FIG. 3 is a front view showing variable display windows of the slot machine according to this embodiment. FIG. 4 is a front view showing an operating panel of the slot machine according to this embodiment.

In FIG. 2, the slot machine 1 has a cabinet 2 which forms the whole of the slot machine 1, wherein an upper liquid crystal display 3 is disposed in the top of the front of such a cabinet 2, and a lower liquid crystal display 4 is disposed in an instrument front panel 20 provided in the central portion of the front of the cabinet 2. The upper liquid crystal display 3 and the lower liquid crystal display 4 are configured from a generally used liquid crystal display.

Also, a pair of speakers 5L, 5R is provided on the left and right of the upper liquid crystal display 3, from which a prescribed BGM, voice, sound effect and the like is output to the player in accordance with a playing status of the slot machine 1. Furthermore, an operating table 6 is provided, projecting forwards, at the bottom of the lower liquid crystal display 4. An authentication unit 7, for mounting the FIG. 13 to be described hereafter, an operating panel 8, on which various buttons are disposed, a coin insertion slot 9 in which a playing medium such as a coin is inserted, and a bill insertion slot 10 in which a bill is inserted are each provided, in order from the left, on the operating table 6. The FIG. 13 and the authentication unit 7 will be described in detail hereafter.

Information relating to the game such as a playing method, a kind of winning combination and its award, and various effects relating to the game, are displayed on the upper liquid crystal display 3. Also, as well as a number of credits which the player currently possesses and various effect images being displayed on the lower liquid crystal display 4, five variable display windows 21, 22, 23, 24 and 25 are displayed around the center thereof. Then, as well as a variety of symbols to be described hereafter being variably displayed as they are scrolled from an upper direction to a lower direction, when a prescribed time has elapsed a prescribed combination of symbols is displayed in a stationary form on each of the variable display windows 21 to 25.

Consequently, the slot machine 1 of this embodiment, having a video reel which is actualized by being displayed via each of the variable display windows 21 to 25 in the lower liquid crystal display 4, is a so-called video slot machine on which a slot game (comprising two kinds of game patterns; a base game and a bonus game) is performed) In the slot game (the base game and the bonus game) according to this embodiment, there are three symbols which are displayed in a stationary form in each of the variable display windows 21 to 25 (fifteen symbols in all).

Specifically, as shown in FIG. 3, the variable display windows 21 to 25 are divided respectively into first stationary display areas 211, 221, 231, 241 and 251, second stationary display areas 212, 222, 232, 242 and 252, and third stationary display areas 213, 223, 233, 243 and 253, wherein a prescribed symbol is displayed in a stationary form in each of the stationary display areas 211 to 213, 221 to 223, 231 to 233, 241 to 243 and 251 to 253 respectively, based on a lottery result according to an internal lottery to be described hereafter.

Also, in the case of the slot game (the base game and the bonus game), there are twenty pay lines formed of five of the stationary display areas 211 to 213, 221 to 223, 231 to 233, 241 to 243 and 251 to 253. In each pay line, in the event that it is activated, an award is allotted when, at the time each symbol is displayed in a stationary form, specified symbols are arranged in a specified manner. At this point, a description will be given of each pay line.

A first pay line L1 is formed of the second stationary display areas 212, 222, 232, 242 and 252. A second pay line L2 is formed of the first stationary display areas 211, 221, 231, 241 and 251. A third pay line L3 is formed of the third stationary display areas 213, 223, 233, 243 and 253. In the same way, a fourth pay line L4 to a twentieth pay line L20 are also each formed using each of the stationary display areas 211 to 213, 221 to 223, 231 to 233, 241 to 243 and 251 to 253.

At this point, of the twenty pay lines, a pay line activated by means of operating each bet button (a BET 1 PER LINE button 33, a BET 3 PER LINE button 34, a BET 5 PER LINE button 35, a BET 7 PER LINE button 36, a BET 10 PER LINE button 37 and a BET 20 PER LINE button 38), to be described hereafter, is referred to as “an activated pay line”.

Also, various operating buttons are disposed on the operating panel 8 provided on the operating table 6. Using FIG. 4 to make a specific description of each operating button, a COLLECT button 31 and a GAME RULES button 32 are disposed, in order from the far left, on the top row of such an operating panel 8, also, the BET 1 PER LINE button 33, the BET 3 PER LINE button 34, the BET 5 PER LINE button 35, the BET 7 PER LINE button 36, the BET 10 PER LINE button 37 and the BET 20 PER LINE button 38 are disposed, in order from the far left, in the center row, and a PLAY 1 LINE button 39, a PLAY 5 LINES button 40, a PLAY 20 LINES button 41, a WIN START FEATURE button 42 and a GAMBLE RESERVE button 43 are disposed, in order from the far left, on the bottom row.

At this point, wherein the COLLECT button 31 is a button which is normally depressed at the end of the game, when the COLLECT button 31 is depressed, coins of a value equivalent to a number of credits obtained in the game are repaid, via a hopper (not shown) provided inside the slot machine 1, from a coin payout opening 15, to be described hereafter, into a coin receiving tray 16. A COLLECT switch 45 is appended to the COLLECT button 31 whereby a switch signal is transmitted to a CPU 50 in response to a depression of the COLLECT button 31 (refer to FIG. 10).

The GAME RULES button 32 is a button which is depressed in the event that a game operation method etc. is unclear whereby, in the event that the GAME RULES button 32 is depressed, various help information is displayed on the upper liquid crystal display 3 and the lower liquid crystal display 4. A GAME RULES switch 46 is appended to such a GAME RULES button 32 whereby a switch signal is transmitted to the CPU 50 from the GAME RULES switch 46 in response to a depression of the GAME RULES button 32 (refer to FIG. 10).

The BET 1 PER LINE button 33 is a button whereby, each time it is depressed, one of the credits which the player currently possesses is bet on each activated pay line. A 1-BET switch 57 is appended to the BET 1 PER LINE button 33 whereby, when the BET 1 PER LINE button 33 is depressed, a switch signal is transmitted to the CPU 50 from the 1-BET switch 57 in response to the depression (refer to FIG. 10).

The BET 3 PER LINE button 34 is a button whereby, in response to a depression thereof, the game is started with three bets on each activated pay line. A 3-BET switch 58 is appended to such a BET 3 PER LINE button 34 whereby, upon depression thereof, a switch signal is transmitted to the CPU 50 from the 3-BET switch 58 (refer to FIG. 10).

Also, the BET 5 PER LINE button 35 is a button whereby, in response to a depression thereof, the game is started with five bets on each activated pay line. A 5-BET switch 59 is appended to the BET 5 PER LINE button 35 whereby, in response to a depression thereof, a switch signal is transmitted to the CPU 50 from the 5-BET switch 59 (refer to FIG. 10).

Consequently, a number of bets bet on each activated pay line is determined by the depression of the BET 1 PER LINE button 33, the BET 3 PER LINE button 34 and the BET 5 PER LINE button 35.

The BET 7 PER LINE button 36, the BET 10 PER LINE button 37 and the BET 20 PER LINE button 38 are buttons whose operating input is enabled in the event that prescribed conditions are fulfilled when performing the game using the FIG. 13.

The BET 7 PER LINE button 36 is a button whereby, in response to a depression thereof, the game is started with seven bets on each activated pay line. A 7-BET switch 60 is appended to the BET 7 PER LINE button 36 whereby, in response to a depression thereof, a switch signal is transmitted to the CPU 50 from the 7-BET switch 60 (refer to FIG. 10).

Also, the BET 10 PER LINE button 37 is a button whereby, in response to a depression thereof, the game is started with ten bets on each activated pay line. A 10-BET switch 61 is appended to the BET 10 PER LINE button 37 whereby, in response to a depression thereof, a switch signal is transmitted to the CPU 50 from the 10-BET switch 61 (refer to FIG. 10).

Also, the BET 20 PER LINE button 38 is a button whereby, in response to a depression thereof, the game is started with twenty bets on each activated pay line. A 20-BET switch 62 is appended to the BET 20 PER LINE button 38 whereby, in response to a depression thereof, a switch signal is transmitted to the CPU 50 from the 20-BET switch 62 (refer to FIG. 10).

Consequently, in the event that the operating input of the BET 7 PER LINE button 36, the BET 10 PER LINE button 37 and the BET 20 PER LINE button 38 is enabled, the number of bets bet on each activated pay line is determined by the depression of the BET 7 PER LINE button 36, the BET 10 PER LINE button 37 and the BET 20 PER LINE button 38. That is, in the event that an opportunity to change the number of bets is provided after the start of the game, the player can change the number of bets by depressing the bet buttons whose operating input is enabled.

The PLAY 1 LINE button 39 is a button whereby, in response to a depression thereof, the game is started with a number of activated pay lines as one. A 1-LINE switch 63 is appended to such a PLAY 1 LINE button 39 whereby, when in response to a depression thereof, a switch signal is transmitted to the CPU 50 from the 1-LINE switch 63 (refer to FIG. 10).

The PLAY 5 LINES button 40 is a button whereby, in response to a depression thereof, the game is started with a number of activated pay lines as five. A 5-LINES switch 64 is appended to the PLAY 5 LINES button 40 whereby, in response to a depression thereof, a switch signal is transmitted to the CPU 50 from the 5-LINES switch 64 (refer to FIG. 10).

The PLAY 20 LINES button 41 is a button whereby, in response to a depression thereof, the game is started with a number of activated pay lines as twenty. A 20-LINES switch 65 is appended to the PLAY 20 LINES button 41 whereby, in response to a depression thereof, a switch signal is transmitted to the CPU 50 from the 20-LINES switch 65 (refer to FIG. 10).

Consequently, a number of activated pay lines is determined by the depression of the PLAY 1 LINE button 39, the PLAY 5 LINES button 40 and the PLAY 20 LINES button 41.

In this way, when the PLAY 1 LINE button 39 is depressed, the aforementioned first pay line L1 is activated. Also, when the PLAY 5 LINES button 40 is depressed, the first pay line L1 to the fifth pay line L5 are activated. Also, when the PLAY 20 LINES button 41 is depressed, the first pay line L1 to the twentieth pay line L20 are all activated.

Also, the PLAY 1 LINE button 39, the PLAY 5 LINES button 40 and the PLAY 20 LINES button 41 also have a role of start buttons based on a depression of any one of which the varying display of symbols is started in each of the variable display windows 21 to 25 in the lower liquid crystal display 4 so as to start the game with the present number of bets and the number of relevant activated pay lines.

The BET 1 PER LINE button 33, the BET 3 PER LINE button 34, the BET 5 PER LINE button 35, the BET 7 PER LINE button 36, the BET 10 PER LINE button 37 and the BET 20 PER LINE button 38 function as input devices of the invention.

Also, the WIN START FEATURE button 42 is a button for the purpose of starting the bonus game, to be described hereafter, and for adding the awards obtained in the bonus game to the credits. A WIN-START switch 47 is appended to such a WIN START FEATURE button 42 whereby, upon depression thereof, a switch signal is transmitted to the CPU 50 from the WIN-START switch 47 (refer to FIG. 10).

The GAMBLE RESERVE button 43 is a button for the purpose of depressing when leaving a seat, and for proceeding to a double down game after the finish of the bonus game. The double down game is a game which is performed using the credits obtained in the bonus game, but the details will be omitted here.

A GAMBLE-RESERVE switch 48 is appended to the GAMBLE RESERVE button 43 whereby, in response to a depression thereof, a switch signal is transmitted to the CPU 50 from the GAMBLE-RESERVE switch 48 (refer to FIG. 10).

A coin sensor 49 is disposed in the coin insertion slot 9 whereby, when a coin is inserted in the coin insertion slot 9, a coin detection signal is transmitted to the CPU 50 (refer to FIG. 10) via the coin sensor 49, and an amount of credits equivalent to the coin inserted is added. Also, a bill sensor 67 is disposed in the bill insertion slot 10 whereby, when a bill is inserted in the bill insertion slot 10, a bill detection signal is transmitted to the CPU 50 (refer to FIG. 10) via the bill sensor 67, and an amount of credits equivalent to the bill inserted is added.

Also, as well as the coin payout opening 15 being formed, the coin receiving tray 16, which receives the coins paid out from the coin payout opening 15, is provided at the bottom of the cabinet 2. A hopper 71, which is capable of ejecting the coins individually, and a coin detector 73, to be described hereafter, comprising a sensor and the like, are disposed in the coin payout opening 15 (refer to FIG. 10), whereby the coin detector 73 detects the number of coins paid out from the coin payout opening 15. Also, it is acceptable to configure it in such a way as to eject a receipt-shaped article on which the number (the value) of the coins is written, instead of directly paying out the coins. In this case, it is possible for the player to exchange the ejected receipt for a gift etc. by taking it to the counter or the like of a game center.

To continue, a description will be given, with reference to FIGS. 5A and 5B, of the FIG. 13 used in the game on the slot machine 1 according to this embodiment, and of the authentication unit 7 which, as well as being provided in the slot machine 1, carries out a reading and writing of information pertaining to the IC tag built into the mounted FIG. 13.

First, a description will be given, with reference to FIGS. 5A and 5B, of the FIG. 13 according to this embodiment. FIGS. 5A and 5B are front views showing the figure according to this embodiment.

As shown in FIG. 5A, the FIG. 13 basically comprises a stand 90 and a figure main body 91. The FIG. 13 corresponds to a readable object of the invention. The stand 90 has a diameter corresponding to the authentication unit 7, to be described hereafter, being formed on a hollow, thick disc. Also, the figure main body 91 is affixed to a top surface 92 of the stand 90, while the IC tag 93 is firmly fitted into the bottom. Inside the FIG. 13, wiring is provided from the IC tag 93 towards the top of the figure main body 91, whereby the IC tag 93 is connected, by means of the wiring, to an LED module 405 disposed in an eye portion of the figure main body 91 (refer to FIG. 5B).

The figure main body 91 is molded of a synthetic resin or the like, with an external appearance of a horse. The form of the figure main body 91 is one which corresponds to a horse appearing in the horse racing game, to be described hereafter. The FIG. 13 of several kinds of color and of differing form are used in the slot machine 1 according to this embodiment. The FIG. 13 each have a different pattern of change (growth as a horse) in a speed value, a stamina value and a will to win value, being set in such a way that, even in the event that the same kind of training is carried out when training (causing the variable parameters to change) in the horse racing game executed on the horse racing game site, to be described hereafter, the growth will be different. The speed value, the stamina value and the will to win value are information which is included in the variable parameter information, the information being stored in the server 120 in this embodiment. The variable parameter information is information which differs according to the figure, wherein the information changes by means of performing the horse racing game to be described hereafter. While the player is able to differentiate between the FIG. 13 by means of the form of the figure main body 91, the slot machine 1 can differentiate between the FIG. 13 by reading a FIG. 1D stored in the IC tag 93. Having read the FIG. 1D, the slot machine 1 reads the variable parameter information corresponding to the FIG. 1D from the server 120. The FIG. 13 are each stored in a capsule of a prescribed size and are sold from a dedicated vending machine provided separately from the slot machine 1.

FIG. 6 is a block diagram showing an internal configuration of an IC tag.

The IC tag 93 comprises a transceiver 401, a controller 402, a memory 403 and an LED driver 404. Also, the LED module 405 is connected to the LED driver 404.

When the controller 402 receives various data (commands) via the transceiver 401, it stores the data received in the memory 403 in accordance with the commands and transmits the data stored in the memory 403 in accordance with the commands received via the transceiver 401.

The FIG. 1D and the like which constitutes a value peculiar to each of the FIG. 13 is stored in the memory 403. The slot machine 1 reads the FIG. 1D, then reads the variable parameter information corresponding to the FIG. 1D from the server 120. Then, the slot machine 1 changes the upper limit of the number of medals bet based on the variable parameter information. The FIG. 1D corresponds to identification information of the invention.

The LED driver 404 carries out display control for the LED module 405. The LED module 405 includes two full color LED's, wherein display control is carried out in accordance with the commands received via the transceiver. For example, red, yellow, green, blue etc. lights are emitted in accordance with the commands received via the transceiver.

Next, a description will be given, with reference to FIGS. 7 and 8, of the authentication unit 7 provided in the slot machine 1 according to this embodiment. FIG. 7 is an exploded perspective view showing the authentication unit 7 provided in the slot machine 1 according to this embodiment. FIG. 8 is a front view showing the authentication unit 7 with a figure mounted thereon.

As shown in FIG. 7, the authentication unit 7 basically comprises a guide member 95, a support frame 96 and a base 97.

The guide member 95 includes a transparent urethane main body 98, which is a thick, plate-like body of a transparent resin, wherein a tapering guide aperture 99, hollowed out in a truncated cone form, is formed in the center of the main body 98. The guide aperture 99 is configured in such a way that the area of the upper opening is greater than the area of the lower opening and it slants towards the inside, wherein the area of the lower opening is approximately identical to the area of the bottom of the stand 90 of the FIG. 13.

Also, a projection 100 is formed in the front of the guide member 95. The projection 100 is disposed in the front of the main body 98, being formed integrally with the main body 98. Furthermore, a seal-like light blocking member 101 is stuck around the guide aperture 99 on the top of the main body 98 in the guide member 95.

The light blocking member 101 has a black surface, and has a role of blocking the light from a full color LED 109, to be described hereafter, provided internally. Also, an alerting unit 102, on which an alerting light shines or flickers, is provided in a portion of the main body 98 farther to the outside than the light blocking member 101. Then, a light is displayed on the alerting unit 102 in accordance with the playing status of the slot machine 1, thereby informing the player of the current playing status of the slot machine 1.

Also, the support frame 96 is of an approximately trapezoidal form whereby, as the guide member 95 is fitted therein, it acts as a support member which supports the guide member 95. Then, when the guide member 95 is fitted, the support frame has a frame body 103 which covers the periphery of the main body 98. Furthermore, a seat 104, in which the stand 90 of the FIG. 13 can be fitted and thereby mounted, is formed in the center of the bottom of the frame body 103.

The seat 104 is formed of a cylindrical space having a diameter slightly larger than the diameter of the stand 90 of the FIG. 13 so that, although the stand 90 of the FIG. 13 is allowed a small amount of play, it is possible to fit the stand 90 and the seat 104 together in such a way that their prescribed relative position is maintained. Furthermore, the depth of the seat 104 is set to be slightly lower than the height of the stand 90. Then, as shown in FIG. 8, the FIG. 13 can be prevented from falling over by positioning the stand 90 in the seat 104.

Also, a projection guide member 105 is provided in a frontal position in the frame body 103. The projection guide member 105 is formed in such a position and of such a size as to conceal the surface of the projection 100 when the main body 98 of the guide member 95 is fitted in the support frame 96.

Furthermore, the base 97 positioned below the support frame 96 comprises a base main body 106 and an IC tag reader/writer 107 installed in the base main body 106. The IC tag reader/writer 107, which acts as an identification information reading module, comprises a controller, a data transceiver and an antenna wherein, in particular, the antenna, which carries out a communication of the IC tag 93 data, is positioned directly below the seat 104 of the support frame 96. Consequently, the communication of data with the IC tag 93 built into the stand 90 of the FIG. 13 mounted in the seat 104 can be reliably carried out.

Then, the IC tag reader/writer 107 configured as described heretofore is connected to the CPU 50, to be described hereafter, whereby it is controlled by the CPU 50 to carry out a reading and writing of the IC tag 93. Although the data communication in this embodiment is carried out via a non-contact method, it is of course possible to carry out by a contact method.

Also, the base 97 includes a back plate 108, which is formed in such a way as to stand up at the back side, wherein the full color LED 109 is attached to the back plate 108. Then, the full color LED 109 emits light in a prescribed light pattern in accordance with the playing status of the slot machine 1, thereby informing the player of the current playing status of the slot machine 1 via the alerting unit 102.

Then, in the slot machine 1 according to this embodiment in which the authentication unit 7, having the heretofore described configuration, is provided, the player inserts a coin through the coin insertion slot 9 then, when the reception etc. of the bet is finished, the CPU 50 determines, via the IC tag reader/writer 107, whether or not the FIG. 13 is mounted on the authentication unit 7. In the event that the CPU 50 determines that the FIG. 13 is mounted, it reads the variable parameter information from the server 120 in accordance with the FIG. 1D read from the IC tag 93 then, in accordance with the variable parameter information, carries out the changing process of the upper limit of the number of coins bet. The process relating to the changing of the upper limit of the number of bets will be described in detail hereafter.

To continue, with reference to FIG. 9, a description will be given of the symbol columns which are variably displayed while scrolling down each of the variable display windows 21 to 25 of the lower liquid crystal display 4 during the base game and the bonus game. In FIG. 9, the symbol column shown in a first reel band 111 is the symbol column variably displayed in the variable display window 21, the symbol column shown in a second reel band 112 is the symbol column variably displayed in the variable display window 22, the symbol column shown in a third reel band 113 is the symbol column variably displayed in the variable display window 23, the symbol column shown in a fourth reel band 114 is the symbol column variably displayed in the variable display window 24, and the symbol column shown in a fifth reel band 115 is the symbol column variably displayed in the variable display window 25.

Dot data for forming images in the symbol columns shown in the first reel band 111 to the fifth reel band 115 are stored in an image ROM 82 (refer to FIG. 11).

At this point, the symbol columns shown in the first reel band 111 to the fifth reel band 115 have a different symbol distribution with respect to each other, wherein each symbol column comprises a suitable combination of thirteen kinds of symbol LOBSTER, SHARK, FISH, PUNK, OCTOPUS, CRAB, WORM, A, K, Q, J, WILD and SARDINE.

Herein, LOBSTER indicates a symbol of a lobster. Also, SHARK, FISH, PUNK, OCTOPUS, CRAB, WORM and SARDINE indicate symbols of a shark, a fish, a person holding a guitar, an octopus, a crab, a worm and a sardine respectively. Also, A, K, Q, J and WILD indicate symbols of each roman letter.

Then, in a case in which a prescribed number of LOBSTER, SHARK, FISH, PUNK, OCTOPUS, CRAB, WORM, A, K, Q, J, WILD and SARDINE are displayed from the left end in a stationary form along the first to the twentieth pay lines L1 to L20, a predetermined number of credits is added to the number of credits which the player possesses (refer to FIG. 13).

Also, SARDINE is a so-called scatter symbol, and in the event that, regardless of the activated pay line, a total of two or more are displayed in a stationary form in the variable display windows 21 to 25, a predetermined number of credits is added to the number of credits which the player possesses (refer to FIG. 13). Furthermore, as will be described hereafter, SARDINE is also a bonus game transition symbol for the purpose of making a transition to the bonus game wherein, regardless of the activated pay line, in the event that a total of four or more are displayed in a stationary form in the variable display windows 21 to 25, it is possible to make a transition to the bonus game.

Also, WILD is a so-called wild symbol which can take the place of any symbol other than SARDINE (the scatter symbol).

Then, the symbol columns shown in the first reel band 111 to the fifth reel band 115, when the game is started by depressing one of the PLAY 1 LINE button 39, the PLAY 5 LINES button 40 and the PLAY 20 LINES button 41, are displayed scrolling from the top direction to the bottom direction in each of the variable display windows 21 to 25, wherein, after the prescribed time has elapsed, three of the symbols are displayed in a stationary form in each of the variable display windows.

Furthermore, wherein each kind of winning combination (refer to FIG. 13) is preset based on a plurality of combinations of the symbols, when a combination of symbols corresponding with a winning combination stops in an activated pay line, the award corresponding to the winning combination is added to the credits. Also, regardless of the pray line, in the event that four or more SARDINE's are simultaneously displayed in a stationary form, a transition is made to the bonus game.

Next, a description will be given, with reference to FIG. 10, of a configuration relating to a control system of the slot machine 1. FIG. 10 is a block diagram which schematically shows the control system of the slot machine.

In FIG. 10, the control system of the slot machine 1 is basically configured with the CPU 50 as a nucleus, wherein an ROM 51 and an RAM 52 are connected to the CPU 50. The CPU 50 functions as a game execution module which executes the game. A main process program, to be described hereafter, a base game process program, a bonus game process program, a symbol lottery table for selecting a stationary display symbol, an award table (refer to FIG. 12) for setting a winning combination based on a combination of symbols displayed in a stationary form as well as a credit paid out in accordance with the winning combination, a bet number upper limit change table (refer to FIG. 20) for determining the upper limit of the number of coins bet by lottery based on the variable parameters, and various kinds of program, data table and the like which are necessary for the control of the slot machine 1, are stored in the ROM 51. Also, the RAM 52 is a memory for temporarily storing the various kinds of data calculated by the CPU 50.

Also, a clock pulse generator 53, which generates a reference clock pulse, and a frequency divider 54 are connected to the CPU 50, as are a random number generator 55, which generates a random number, and a random number sampling circuit 56. The random number sampled via the random number sampling circuit 56 is used for the various kinds of lottery of the winning combinations etc. Furthermore, the COLLECT switch 45 appended to the COLLECT button 31, the GAME-RULES switch 46 appended to the GAME RULES button 32, the 1-BET switch 57 appended to the BET 1 PER LINE button 33, the 3-BET switch 58 appended to the BET 3 PER LINE button 34, the 5-BET switch 59 appended to the BET 5 PER LINE button 35, the 7-BET switch 60 appended to the BET 7 PER LINE button 36, the 10-BET switch 61 appended to the BET 10 PER LINE button 37, the 20-BET switch 62 appended to the BET 20 PER LINE button 38, the WIN-START switch 47 appended to the WIN START FEATURE button 42, the 1-LINE switch 63 appended to the PLAY 1 LINE button 39, the 5-LINES switch 64 appended to the PLAY 5 LINES button 40, the 20-LINES switch 65 appended to the PLAY 20 LINES button 41, and the GAMBLE RESERVE switch 48 appended to the GAMBLE RESERVE button 43, are each connected to the CPU 50. Based on the switch signal output by each switch according to the depression of each button, the CPU 50 carries out control so as to execute the various kinds of operation corresponding to each button.

Furthermore, the coin sensor 49 disposed in the coin insertion slot 9 and the bill sensor 67 disposed in the bill insertion slot 10 are each connected to the CPU 50. The coin sensor 49 detects the coins inserted through the coin insertion slot 9, whereby the CPU 50 calculates the number of coins inserted based on the coin detection signal transmitted from the coin sensor 49. The bill sensor 67 detects the kind and value of the bills inserted through the bill insertion slot 10, whereby the CPU 50 calculates the number of credits equivalent to the value of the bills, based on the bill detection signal transmitted from the bill sensor 67.

A hopper 71 is connected to the CPU 50 via a hopper drive circuit 70. When a drive signal is transmitted to the hopper drive circuit 70 from the CPU 50, the hopper 71 pays out the prescribed number of coins from the coin payout opening 15.

Also, a coin detector 73 is connected to the CPU 50 via a payout completion signal circuit 72. The coin detector 73 is disposed inside the coin payout opening 15 wherein, in a case in which a prescribed number of coins is detected to have been paid out from the coin payout opening 15, a coin payout detection signal is transmitted from the coin detector 73 to the payout completion signal circuit 72, based on which the payout completion signal circuit 72 transmits a payout completion signal to the CPU 50. Furthermore, the upper liquid crystal display 3 and the lower liquid crystal display 4 are connected to the CPU 50 via a liquid crystal drive circuit 74, wherein the upper liquid crystal display 3 and the lower liquid crystal display 4 are controlled by the CPU 50.

As shown in FIG. 11, the liquid crystal drive circuit 74 comprises a program ROM 81, an image ROM 82, an image control CPU 83, a work RAM 84, a VDP (video display processor) 85, a video RAM 86 and the like. An image control program related to the display on the upper liquid crystal display 3 and the lower liquid crystal display 4, and various kinds of lottery table, are stored in the program ROM 81. Also, dot data for forming images, such as the first reel band 111 to the fifth reel band 115 in FIG. 9 displayed on the lower liquid crystal display 4 (or the variable display windows 21 to 25), an effect image which indicates that the number of bets can be changed (refer to FIG. 21) and the like, are stored in the image ROM 82.

The image control CPU 83 determines the image to be displayed on the upper liquid crystal display 3 and the lower liquid crystal display 4 from the dot data previously stored in the image ROM 82, based on the parameters set by the CPU 50, in accordance with an image control program previously stored in the program ROM 81. Also, the work RAM 84 is configured as a temporary memory when the image control program is executed by the image control CPU 83. Furthermore, the VDP 85 forms an image corresponding to the display details determined by the image control CPU 83, and transmits it to the upper liquid crystal display 3 and the lower liquid crystal display 4. By this means, for example, the symbol columns and the like displayed in the reel bands 111 to 115 are displayed in a scrolling form on the lower liquid crystal display 4 (or the variable display windows 21 to 25). The video RAM 86 is configured as a temporary memory when the image is formed by the VDP 85.

Also, LED's 78 are connected to the CPU 50 via an LED drive circuit 77. A large number of the LED's 78 are distributed on the front of the slot machine 1 wherein, when various kinds of effect are executed, illumination control is carried out by the LED drive circuit 77 based on a drive signal from the CPU 50. In particular, in the slot machine 1 according to this embodiment, the LED's 78 are illuminated to increase the effect at the time of the bonus game and the like, to be described hereafter.

Also, a sound output circuit 79 and the speakers 5L and 5R are connected to the CPU 50, wherein the speakers 5L and 5R, based on an output signal from the sound output circuit 79, emit voices and sound effects when the various effects are performed.

Also, as shown in FIG. 12, a symbol lottery table 51A, which determines, based on a random number value, the symbols to be displayed in a stationary form in each of the stationary display areas 211 to 213, 221 to 223, 231 to 233, 241 to 243 and 251 to 253 (refer to FIG. 3) of the variable display windows 21 to 25, an award table 51B, which stores the winning combinations and awards for each symbol displayed in a stationary form in each stationary display area, and the bet number upper limit change table 51C (refer to FIG. 20), which is used when determining the upper limit of the number of coins bet based on the variable parameter information and the random number value, are stored in the ROM 51.

Next, a description will be given of the symbol lottery table 51A stored in the ROM 51, which is used when determining the symbols to be displayed in a stationary form in each of the stationary display areas 211 to 213, 221 to 223, 231 to 233, 241 to 243 and 251 to 253 (refer to FIG. 3) in a case of performing the base game and the bonus game on the slot machine 1 using the five variable display windows 21 to 25.

The symbol lottery table 51A is a lottery table which selects the symbols to stop on the first activated pay line L1, which comprises the second stationary display areas 212, 222, 232, 242 and 252, based on the random number value sampled by the random number sampling circuit 56. Then, by determining the symbols to stop in the second stationary display areas 212, 222, 232, 242 and 252, the symbols to be displayed in a stationary form in the first and third stationary display areas 211, 213, 221, 223, 231, 233, 241, 243, 251 and 253, above and below it, are also determined from the symbol distribution of the reel bands (refer to FIG. 9). Specifically, a symbol with a code number one smaller than the code number determined based on the random number value is displayed in a stationary form in the first stationary display areas 211, 221, 231, 241 and 251, while a symbol with a code number one larger than the code number is displayed in a stationary form in the third stationary display areas 213, 223, 233, 243 and 253.

Also, in the slot machine 1 according to this embodiment, the symbols displayed in a stationary form on the activated pay line L1 are determined for each of the variable display windows 21 to 25. The symbol lottery table 51A allots a code number from 00 to 29, in order from the top, to each of the symbol columns displayed in first reel band 111 to the fifth reel band 115 in FIG. 9, while setting the random number value corresponding to each code number.

Then, at the start of the game, the CPU 50 samples five random number values to correspond with each of the variable display windows 21 to 25 via the random number sampling circuit 56, thereby determining the symbols to stop in the second stationary display areas 212, 222, 232, 242 and 252 in each of the variable display windows 21 to 25 (for example, in a case in which the random number value sampled is 9, the FISH symbol (fish) allotted to the code no. 09 is displayed in a stationary form in the second stationary display area).

Next, a description will be given, with reference to FIG. 13, of the winning combinations and the awards thereof in the case of performing the base game and the bonus game on the slot machine 1 using the five variable display windows 21 to 25. FIG. 13 is the award table 51B which shows the winning combinations and the awards thereof in the case of performing the game using the five variable display windows, wherein the award is shown in a case in which the number of bets is one. Consequently, although the award value shown in FIG. 13 is added to the credits in the event that the number of bets is one, in the event that the number of bets is two or more, the product of the relevant number of bets and the award value shown in FIG. 13 is added to the credits.

At this point, to give a specific description of a winning combination and the award thereof in the case of performing the base game, as shown in FIG. 13, regarding the LOBSTER symbol (lobster), in the event that it is consecutively displayed in a stationary form on an activated pay line in the variable display windows 21 to 22 (in the case of 2K in which two appear consecutively from the left end), an award of 10 is obtained. Also, in the event that it is consecutively displayed in a stationary form on an activated pay line in the variable display windows 21 to 23 (in the case of 3K in which three appear consecutively from the left end), an award of 320 is obtained. Also, in the event that it is consecutively displayed in a stationary form on an activated pay line in the variable display windows 21 to 24 (in the case of 4K in which four appear consecutively from the left end), an award of 2500 is obtained. Also, in the event that it is consecutively displayed in a stationary form on an activated pay line in the variable display windows 21 to 25 (in the case of 5K in which five appear consecutively from the left end), an award of 6000 is obtained.

Also, regarding the SHARK symbol (shark), in the event that it is consecutively displayed in a stationary form on an activated pay line in the variable display windows 21 to 22 (in the case of 2K in which two appear consecutively from the left end), an award of 3 is obtained. Also, in the event that it is consecutively displayed in a stationary form on an activated pay line in the variable display windows 21 to 23 (in the case of 3K in which three appear consecutively from the left end), an award of 25 is obtained. Also, in the event that it is consecutively displayed in a stationary form on an activated pay line in the variable display windows 21 to 24 (in the case of 4K in which four appear consecutively from the left end), an award of 150 is obtained. Also, in the event that it is consecutively displayed in a stationary form on an activated pay line in the variable display windows 21 to 25 (in the case of 5K in which five appear consecutively from the left end), an award of 1000 is obtained.

In the same way, the award is set, as shown in FIG. 13, for each of the FISH symbol (fish), the PUNK symbol (person holding a guitar), the OCTOPUS symbol (octopus), the CRAB symbol (crab), the WORM symbol (worm), the A symbol (roman letter), the K symbol (roman letter), the Q symbol (roman letter) and the J symbol (roman letter).

Then, in the event that the award for the symbols is on a plurality of activated pay lines, the total value of all the awards is added to the credits.

Regarding the SARDINE symbol (sardine), however, being the scatter symbol, in the case of 2K in which two appear (displayed in a stationary form), regardless of the activated pay lines, in the variable display windows 21 to 25, an award of 2 is obtained, in the case of 3K in which three appear (displayed in a stationary form), an award of 5 is obtained, in the case of 4K in which four appear (displayed in a stationary form), an award of 10 is obtained, and in the case of 5K in which five appear (displayed in a stationary form), an award of 125 is obtained.

Only in the case of the award for the SARDINE symbol (sardine), the product of the total number of bets (the product of the number of bets and the number of activated pay lines) and the award value shown in FIG. 13 is added to the credits. At this time, in the event that there is an award other than for the SARDINE symbol (sardine), that award is also added to the credits.

Also, as the SARDINE symbol (sardine) is also the trigger symbol for making a transition to the bonus game, in the event that four or more appear simultaneously (displayed in a stationary form), regardless of the activated pay lines, in the variable display windows 21 to 25, as well as obtaining the award, it is possible to make a transition to the bonus game.

A description will now be given of the bonus game. The bonus game is a game which is started by specified conditions being fulfilled during the base game, wherein it is often the case that it is a game which in general is beneficial to the player. At this point, when a transition is made to the bonus game, fifteen to twenty-five games are automatically performed consecutively in accordance with a lottery result when a transition is made to the bonus game, with no need to bet the credits or the like (a so-called free game).

The number of bets and the number of activated pay lines at the time of making a transition to the bonus game are used respectively during the bonus game. Also, although the winning combinations and the awards thereof in the bonus game are the same as in the base game heretofore described, as well as the SHARK symbol (shark) being used as the LOBSTER symbol (lobster), in the event that a total of four SARDINE symbols (sardine) appear (displayed in a stationary form), it is possible to make a transition again to the bonus game. At this point, as shown in FIG. 13, as the award in the case of the LOBSTER symbol (lobster) being won is set high in comparison with the SHARK symbol (shark), the player does not expend the credits during the bonus game, and there is also a high possibility of obtaining a large number of credits and the like.

To continue, a description will be given, with reference to FIG. 14, of the main process program of the slot machine 1 according to this embodiment having the aforementioned configuration. FIG. 14 is a flowchart of the main process program of the slot machine according to this embodiment. Each program shown as a flowchart in FIGS. 14 to 19 to follow is stored in the ROM 51 and the RAM 52 included in the slot machine 1, wherein they are executed by the CPU 50.

In FIG. 14, first, in step (hereafter abbreviated to S) 1, a start reception process in FIG. 15, to be described hereafter, is carried out. The process is one which receives a switch signal transmitted from the 1-BET switch 57, the 3-BET switch 58, the 5-BET switch 59, the 1-LINE switch 60, the 5-LINES switch 61 and the 20-LINES switch 62, based on an operation of the BET 1 PER LINE button 33, an operation of the BET 3 PER LINE button 34, an operation of the BET 5 PER LINE button 35, an operation of the PLAY 1 LINE button 39, an operation of the PLAY 5 LINES button 40 and an operation of the PLAY 20 LINES button 41. The game is started at the point when the switch signal transmitted from each switch is received.

Then, in S2, a lottery process in FIG. 17, to be described hereafter, is carried out based on the switch signal transmitted from the 1-LINE switch 60, the 5-LINES switch 61 and the 20-LINES switch 62.

At this point, in the case of winning the bonus game (in the case that four or more of the SARDINE symbols (sardine) are simultaneously displayed in a stationary form, regardless of the activated pay line, in the variable display windows 21 to 25), the bonus game, to be described hereafter, is performed after the finish of the current base game (refer to FIG. 22).

In S3, a base game process in FIG. 18, to be described hereafter, is carried out. After that, proceeding to S4, it is determined whether or not the bonus game has been won. Specifically, in the case that, in the lottery process in S2, a total of four or more of the SARDINE symbols (sardine) are displayed in a stationary form, regardless of the activated pay line, in the variable display windows 21 to 25, the bonus game has been won (S4: YES) so, proceeding to S5, after the bonus game process in FIG. 22, to be described hereafter, has been carried out, a history updating process (S6), to be described hereafter, is carried out. On the contrary, in the case that, in the lottery process in S2, a total of four or more of the SARDINE symbols (sardine) are not displayed in a stationary form, regardless of the activated pay line, in the variable display windows 21 to 25, the main process program is finished.

To continue, a description will be given, with reference to FIG. 15, of the start reception process carried out in S1 on the slot machine 1 according to this embodiment. FIG. 15 is a flowchart of the start reception process of the slot machine according to this embodiment.

In the start reception process, first, in S11 the CPU 50 determines whether or not a prescribed time (for example, fifteen seconds) has elapsed. At this point, if it is determined that the prescribed time has not elapsed (S11: NO), the process proceeds to S13 without doing anything but, if it is determined that the prescribed time has elapsed (S11: YES), after a demo effect is executed on the upper liquid crystal display 3 and the lower crystal display 4 in S12, the process proceeds to S13.

Then, in S13, it is determined whether or not the BET 1 PER LINE button 33 operation, the BET 3 PER LINE button 34 operation, the BET 5 PER LINE button 35 operation, the PLAY 1 LINE button 39 operation, the PLAY 5 LINES button 40 operation and the PLAY 20 LINES button 41 operation have been performed. At this point, if is determined that the operation of the PLAY 1 LINE button 39 etc. have not been performed (S13: NO), the process returns to S11 where the previously described process is repeated while, if it is determined that the operation of the PLAY 1 LINE button 39 etc. have been performed (S13: YES), the process continues to a figure mounting evaluation process in S14, even if the demo effect is still in progress. It is acceptable, in the determination process in S13, to determine using an input signal other than the operation signals.

In S14, it is determined whether or not the FIG. 13 is mounted on the authentication unit 7. Specifically, it is determined whether or not the communication of data is possible with the IC tag 93 built into the stand 90 of the FIG. 13 via the IC tag reader/writer 107. Then, if it is determined that the FIG. 13 is not mounted (S14: NO), the start reception process is finished, and a shift is made to the lottery process (S2).

Meanwhile, if it is determined that the FIG. 13 is mounted on the authentication unit 7 (S14: YES), the FIG. 1D is read from the IC tag 93 built into the mounted figure via the IC tag reader/writer 107 (S15).

To continue, in S16, in a variable parameter information reading process in FIG. 16, to be described hereafter, the variable parameter information corresponding to the FIG. 1D read in S15 is read from the server 120. After that, the start reception process is finished, and a shift is made to the lottery process (S2).

FIG. 16 is a flowchart showing a sub-routine of the variable parameter information reading process called up and executed in S16 of the flowchart shown in FIG. 15.

First, in S17, the FIG. 1D read (refer to S15) is transmitted to the server 120. The server 120 which receives the FIG. 1D extracts the variable parameter information (refer to FIG. 27) corresponding to the FIG. 1D from the hard disc drive, and transmits it to the slot machine 1 which receives the FIG. 1D.

Next, in S18, the variable parameter information is received from the server 120. The variable parameter information is the information extracted from the hard disc drive of the server 120 in response to the FIG. 1D transmitted to the server 120 in S17. When this process is finished, the process is moved to S19. In S17 and S18, the CPU 50 of the slot machine 1 functions as a parameter reading module which reads the variable parameter information.

In S19, an operation command is transmitted to the FIG. 13. The operation command is one which includes an instruction which causes the full color LED's included in the LED module 405 of the FIG. 13 to be illuminated in response to the variable parameter information received (refer to S18). Specifically, the instruction is included whereby a red illumination is caused in a case in which a number of wins included in the variable parameter information received is between zero wins and nine wins inclusive, a yellow illumination is caused in a case of ten wins to nineteen wins, a green illumination is caused in a case of twenty wins to twenty-nine wins, and a blue illumination is caused in a case of thirty or more wins. When this process is finished, the variable parameter information reading process is finished. The number of wins refers to a number of wins in the horse racing game to be described hereafter. In S19, the CPU 50 of the slot machine 1 functions as a controller which controls in such a way as to cause the FIG. 13 to perform the operations corresponding to the variable parameter information.

Next, a description will be given, with reference to FIG. 17, of the lottery process carried out in S2 in the slot machine 1 according to this embodiment. FIG. 17 is a flowchart of the lottery process in the slot machine according to this embodiment.

In the lottery process, first, a symbol determining process is carried out in S21. At this point, in the base game, the symbol to be displayed in a stationary form on the first pay line L1 is determined for each of the variable display windows 21 to 25. Specifically, as described heretofore, five random number values to correspond with each of the variable display windows 21 to 25 are sampled via the random number sampling circuit 56, and the code numbers are determined from the symbol lottery table 51A. Furthermore, the symbols to be displayed in a stationary form in each of the variable display windows 21 to 25 are determined based on the code numbers and the first reel band 111 to the fifth reel band 115.

Then, when the symbols to be displayed in a stationary form on the activated pay lines have been determined, after a winning combination evaluation process has been carried out in S22, the process returns to the main process program, and proceeds to the base game process in S3. In the winning combination evaluation process, to be specific, the winning combinations and the awards thereof are determined based on the symbols determined in S21 and the award table 51B in FIG. 12.

Next, a description will be given, with reference to FIG. 18, of the base game process carried out in S3 in the slot machine 1 according to this embodiment. FIG. 18 is a flowchart of the base game process program in the slot machine according to this embodiment.

In the base game process, first, in S31, the scrolling of each symbol is carried out in the variable display windows 21 to 25 based on the switch signals transmitted from the 1-LINE switch 60, the 5-LINES switch 61 and the 20-LINES switch 62, which are received in the start reception process (S1).

To continue, in S32, in the varying stage before the symbols stop in the variable display windows 21 to 25, as well as the upper limit of the number of coins bet being changed if the prescribed conditions are fulfilled, a bet number upper limit change process is carried out wherein the change in the number of bets is received. The bet number upper limit change process will be described in detail hereafter using FIG. 19.

After that, the scrolling of each symbol in the variable display portions 21 to 25 is stopped (S33).

Furthermore, in S34, in accordance with the winning combinations of symbol displayed in a stationary form in each of the variable display windows 21 to 25 in S33, credits and the like equivalent to the awards determined based on the award table 51B in FIG. 12 are paid out. Then, after this payout process, the process returns to the main process program and proceeds to the determination process in S4.

Next, a description will be given, with reference to FIG. 19, of the bet number upper limit change process carried out in S32 in the slot machine 1 according to this embodiment. FIG. 19 is a flowchart of the bet number upper limit change process program in the slot machine according to this embodiment.

In the bet number upper limit change process, first, the random numbers are sampled in the range of 0 to 79 by the random number sampling circuit 56 in S41.

Next, it is determined whether or not the bet number upper limit has been changed in S42. If it is determined that the bet number upper limit has been changed, the process is moved to S43 while, if it is determined that the bet number upper limit has not been changed, the bet number upper limit change process is finished. The determining of whether or not the bet number upper limit has been changed is based on the random number value obtained in S41 and the bet number upper limit change table.

FIG. 20 shows one example of the bet number upper limit change table which determines the bet number upper limit based on the variable parameter information.

The variable parameter information, being information which differs depending on the figure, varies according to the performance of the horse racing game, to be described hereafter. In this embodiment, a description will be given of a case in which the bet number upper limit is changed based on the number of wins in the horse racing game, to be described hereafter, which is included in the variable parameter information.

A random number extraction value is stored in the left hand column of the bet number upper limit change table, while the bet number upper limit value corresponding to each number of wins is stored in the column to the right in such a way as to be correlated to each random number extraction. The bet number upper limit change table is a look-up table wherein, for example, in a case in which the number of wins is 0 to 9, in the event that the random number extraction value is between 0 and 31 inclusive, the bet number upper limit is changed to 7. In the event that the random number extraction value is between 32 and 79 inclusive, the bet number upper limit remains unchanged at 5. In a case in which the figures are not used, the number of wins is 0.

Also, for example, in a case in which the number of wins is 10 to 19, in the event that the random number extraction value is between 0 and 31 inclusive, the bet number upper limit is determined to be 10, in the event that the random number extraction value is between 32 and 47 inclusive, the bet number upper limit is determined to be 7. In the event that the random number extraction value is between 33 and 79 inclusive, the bet number upper limit remains unchanged at 5.

Also, for example, in a case in which the number of wins is 20 to 29 inclusive, in the event that the random number extraction value is between 0 and 31 inclusive, the bet number upper limit is determined to be 20, in the event that the random number extraction value is between 32 and 47 inclusive, the bet number upper limit is determined to be 10, in the event that the random number extraction value is between 48 and 63 inclusive, the bet number upper limit is determined to be 7. In the event that the random number extraction value is between 64 and 79 inclusive, the bet number upper limit remains unchanged at 5.

Also, for example, in a case in which the number of wins is 30 or more, in the event that the random number extraction value is between 0 and 47 inclusive, the bet number upper limit is determined to be 20, in the event that the random number extraction value is between 48 and 63 inclusive, the bet number upper limit is determined to be 10, in the event that the random number extraction value is between 64 and 79 inclusive, the bet number upper limit is determined to be 7.

In this way, the larger the number of wins indicated by the variable parameter information, the greater the possibility that the bet number upper limit is changed to a high level.

If it is determined that the bet number upper limit has been changed (S42: YES), a bet number change signal is received (S43). In this process, in response to the changed bet number upper limit, as well as enabling the operation of the BET 7 PER LINE button 36, the BET 10 PER LINE button 37 and the BET 20 PER LINE button 38, an effect is started to indicate that the bet number can be changed. When this process is finished, the process is moved to S44.

FIG. 21 shows an effect which indicates that the bet number indicated in the lower liquid crystal display can be changed.

For example, in S42, if it is determined that the bet number upper limit has been changed to 20, a display saying “YOU CAN BET 20 PER LINE!!” is displayed in the lower liquid crystal display, as shown in FIG. 21.

In S44, it is determined whether or not there has been a signal to the effect that the number of bets is to be changed. In this process, it is determined whether or not one of the bet buttons for which input is possible has been operated. If it is determined that there has been no operation, it is determined whether or not a prescribed time has elapsed (S45). If it is determined that the prescribed time has not elapsed, the process is returned to S44, while, if the prescribed time has elapsed, the bet number upper limit change process is finished.

Meanwhile, if it is determined that there has been a signal to the effect that the number of bets is to be changed (S44: YES), the bet number is changed to the bet number corresponding to the bet button pressed (S46). After that, the bet number upper limit change process is finished. In the bet number upper limit change process shown in FIG. 19, the CPU 50 functions as a process execution module which executes the process appropriate to the FIG. 1D and the variable parameter information.

To continue, a description will be given, with reference to FIG. 22, of the bonus game process carried out in S5 in the slot machine 1 according to this embodiment. FIG. 22 is a flowchart of the bonus game process program in the slot machine according to this embodiment.

In the bonus game process, first, a number of bonus games T is set in S51. The number of bonus games is selected by lot to be one of ten to twenty-five games inclusive based on the random number value sampled by the random number sampling circuit 56. The set number of bonus games T is stored in the RAM 52.

To continue, a bonus game symbol determining process is carried out in S52. In this process, in the bonus game, the symbol to be displayed in a stationary form on the first pay line L1 is determined for each of the variable display windows 21 to 25. Specifically, as described heretofore, five random number values to correspond with each of the variable display windows 21 to 25 are sampled via the random number sampling circuit 56, and the code numbers are determined from the symbol lottery table 51A. Furthermore, the symbols to be displayed in a stationary form in each of the variable display windows 21 to 25 are determined based on the code numbers and the first reel band 111 to the fifth reel band 115.

Then, when the symbols to be displayed in a stationary form on the activated pay lines have been determined, in S53, in accordance with the symbols determined in S52 and the award table 51B in FIG. 12, the winning combinations and the awards thereof are determined. In the bonus game, however, the SHARK symbol (shark) is used as the LOBSTER symbol (lobster).

Furthermore, in the winning combination evaluation process in S53, it is determined whether or not the trigger combination for making a transition to the bonus game (the case in which four or more SARDINE symbols (sardine) are simultaneously displayed in a stationary form, regardless of the pay lines, in the variable display windows 21 to 25) has been won (S54). Then, if the bonus game trigger combination has been won (S54: YES), a bonus game repetition number t is again determined by lot, whereby the determined repetition number t is added to the existing bonus game number T (S55). In this way, in the event that a bonus game is won during the bonus game, the number of remaining bonus games increases. To be specific, for example, in a case of making a transition for the first time to twenty bonus games, in the event that seventeen bonus games are won in the twelfth of the twenty bonus games, twenty five (twenty games−twelve games+seventeen games) bonus games are performed after that. Meanwhile, if the bonus game trigger combination has not been won (S54: NO), the process moves to S56.

Then, in a symbol variation process in S56, the scrolling of each symbol in the variable display windows 21 to 25 is automatically carried out. Then, in a stop control process in S57, the scrolling of each picture in the variable display windows 21 to 25 is stopped.

Then, in a payout process in S58, in accordance with the winning symbol combinations displayed in a stationary form in each of the variable display windows 21 to 25 in S57, the credits and the like equivalent to the awards determined based on the award table 51B in FIG. 12 (in the bonus game, however, the SHARK symbol (shark) is used as the LOBSTER symbol (lobster)) are paid out.

After that, in S59, the CPU 50 reads the number of bonus games T stored in the RAM 52, and reduces the read game number T by one. Then, the reduced game number T is once more stored in the RAM 52.

Then, in S60, the CPU 50 determines whether or not the number of bonus games T has reached the number determined in S51. Specifically, it is determined whether or not the game number T stored in the RAM 52 has become zero wherein, if the game number T is not zero, that is, if it is determined that the number of bonus games executed has not reached the number determined in S51 (S60: NO), the process returns to S52, and the process described heretofore is repeated. Meanwhile, if the game number T is zero, that is, if it is determined that the number determined in S51 has been reached (S60: YES), the bonus game process program is finished.

Next, a description will be given of the horse racing game performed on the Internet horse racing game site, being distinct from the game performed on the slot machine 1. The horse racing game is executed on the server 120 based on the various commands input into each of the player terminals 121. In the horse racing game, the player can rear a horse, corresponding to the FIG. 13 which he or she separately buys or the like, in an imaginary space on the Internet, and have it participate in a race. In this embodiment, under the auspices of the server 120, on the horse race game site, for example, five races are held from 7 p.m. every day. All the players using the player terminals 121 can take part in the races.

FIG. 23 is a flowchart of the main process program of the horse racing game carried out on the horse racing game site.

In the process shown in FIG. 23, the server 120 functions as a game execution module which executes the game on the web.

First, when the horse racing game program is executed, in S101, the server 120 receives a player ID input.

When the player ID is received, a horse registration and rearing process, to be described hereafter using FIG. 24, is carried out (S102). In this process, when the FIG. 1D written on the FIG. 13 with an outward appearance of the horse purchased separately, or written in the manual and the like attached along with the FIG. 13, is registered, the server 120 stores the variable parameter information corresponding to the FIG. 1D in a prescribed area of the hard disc drive. Also, if an instruction to train the horse corresponding to the FIG. 13 appearing during the game is input via an operation by the player, the performance value of the horse (variable parameter information) is changed in accordance with the contents of the instruction.

Next, in S103, a race process, to be described hereafter using FIG. 25, is executed. In this process, the server 120 causes the player's horse to participate in the race, then changes and stores the number of wins (variable parameter information) in accordance with a result of the race.

Next, in S104, if the game is finished, the program is finished while, if the game is not finished, the process is returned to S102.

FIG. 24 is a flowchart of the horse registration and rearing program which is called up and executed in S102 of FIG. 23.

First, in S110, the FIG. 1D registration is carried out. In this process, the registration of the FIG. 1D according to the player's input is received. The FIG. 1D is written on the FIG. 13 of the horse purchased separately by the player, or written in the manual or the like attached along with the FIG. 13.

Next, in S111, the horse to be used in the game is selected. In this process, a selection input is received regarding which of the FIG. 13 with a corresponding horse is to be used in the race. That is, in a case in which the player possesses a plurality of FIG. 13, a selection input is received regarding which of the FIG. 13 with a corresponding horse is to be used in the race.

Next, in S112, the information about the selected horse is displayed.

FIG. 26 shows one example of a screen image displayed in S112.

The screen image is generated based on the player data, to be described hereafter using FIG. 27. An image representing the selected horse is displayed on the left side of the screen. Also, a past record (number of wins) and a numerically indicated performance value of the horse (speed, stamina, will to win) are displayed on the right side of the screen.

Next, in S113, it is determined whether or not rearing (training) is to be carried out. In this process, it is determined whether or not an instruction to the effect that training is to be carried out has been input by the player's operation. If it is determined that rearing (training) is to be carried out, the process is moved to S114 while, if it is determined that rearing (training) is not to be carried out, the process is moved to S116.

In S114, a training process is carried out. In the training process, for example, a display process is carried out wherein a not-shown training stable selection screen is displayed in a display portion (for example, a liquid crystal display device) of the player terminal 121, wherein the player is asked to select the training stable to be used for the training of the horse from among three kinds of training stable displayed on the screen; a will to win training stable, a stamina training stable and a speed training stable. In this case, the horse can be trained respectively to be a horse with the ability to realize its potential in a close-fought race if the will to win training stable is selected, a long-distance type horse if the stamina training stable is selected, and a short-distance type horse if the speed training stable is selected. That is, if the will to win training stable is selected, the will to win value can be increased, if the stamina training stable is selected, the stamina value can be increased, and if the speed training stable is selected, the speed value can be increased. If the training fails, the performance value may be reduced.

Next, in S115, the performance value is updated as increased or reduced variable parameter information. In this process, the performance value of the horse registered in the server 120 is updated as the performance value increased or reduced according to the training process. In this process, the server 120 functions as an update module which updates the variable parameter information. After this process, the process is moved to S116.

FIG. 27 shows one example of the player data stored in the hard disc drive of the server 120.

The player data comprises individual information and horse information. The individual information comprises the player ID, password and the like. The player ID is individually allotted to the player in order to identify him or her. The password is for the purpose of confirming that the player ID has been input by the player. The horse information comprises the FIG. 1D, the speed value, the stamina value, the will to win value, the number of wins and the like. If there is a plurality of horses, the FIG. 1D, the speed value, the stamina value, the will to win value, the number of wins and the like are correlated for each horse. The server 120, as well as functioning as an identification information storage module which stores the FIG. 1D of the figure, also functions as a parameter information storage module which stores the variable parameter information in such a way that it is correlated to the FIG. 1D.

In S116, it is determined whether or not the rearing (training) is to be finished. In this process, it is determined whether or not an instruction to the effect that training is to be finished has been input by the player's operation. If it is determined that rearing (training) is not to be finished (S116: NO), the process is returned to S111, the horse to be used in the game is selected again, and the selected horse is trained. Meanwhile, if it is determined that rearing (training) is to be finished (S116: YES), the horse registration and rearing process is finished.

FIG. 25 is a flowchart of the race process program called up and executed in S103 of FIG. 23.

First, in S120, entry registration is carried out. In this process, entry registration is received via the player's input. The player selects the horse to enter in the race from among the horses owned and inputs-it.

Next, in S121, a race execution process is carried out. In this process, the server 120 proceeds with the race based on the performance value of each horse participating in the race. In this process, as well as a kind of race screen shown in FIG. 28 being updated and displayed on the player terminal approximately every five seconds, effects are performed according to sounds such as cheering.

When the race is finished, in S122, the race result is displayed. In this process, the server 120 causes the race result to be displayed in the player terminal 121.

Next, in S123, the variable parameter information is updated. In this process, the server 120 updates the number of wins as variable parameter information for each horse, in response to the race result, and stores it in the hard disc drive. In this process, the server 120 functions as an update module which updates the variable parameter information.

Next, in S124, it is determined whether or not to enter in the next race. In this process, it is determined whether or not an instruction to the effect that entry will be made in the next race has been input by the player's operation. If it is determined that entry will be made in the next race (S124: YES), the process is returned to S120, entry registration is carried out again, and the race is executed. Meanwhile, if it is determined that entry will not be made in the next race (S124: NO), the race process is finished.

In this embodiment, a description has been given of a case in which the player terminal 121 is a general-purpose personal computer. However, the player terminal 121 is not limited to this example as long as it can be connected to the Internet and thus access the horse racing game site to enable necessary operations and processes. It is also acceptable to use a household gaming machine, a gaming machine specifically for use in a horse racing game (for example, an arcade gaming machine installed in a game center), a domestic electrical appliance such as a television, or a mobile communication device such as a mobile telephone.

In this embodiment, although an explanation has been given of a case in which the variable parameter information is stored in the hard disc drive included in the server 120, the invention is not limited to this example as it is also acceptable to store the variable parameter information in the IC tag 93 included in the FIG. 13. In the case of a configuration wherein the variable parameter information is stored in the IC tag 93 included in the FIG. 13, it is preferable to use a gaming machine specifically for use in a horse racing game (for example, an arcade gaming machine) in place of the player terminal 121. This is because, in the case of this kind of configuration, it is necessary that the player terminal 121 is equipped with an IC tag reader/writer and the like, in order to update and store the variable parameter information, which varies in the horse racing game, in the IC tag 93.

In the embodiment, although a description has been given of a case in which the readable object is one modeled on the external appearance of a horse which appears in the horse racing game, the readable object of the invention is not limited to this example. Also, in this embodiment, although a description has been given of a case in which the game not executed on the gaming machine is the horse racing game executed on the horse racing game site controlled and managed by the server 120, the game not executed on the gaming machine is not limited to this example in the invention. For example, it is also acceptable for it to be a car racing game or a mah-jong game. In this case, it is preferable that the readable object has the form modeled on a character and the like appearing in the game.

Heretofore, according to the slot machine 1 of this embodiment, the variable parameter information of the FIG. 13 (performance value, number of wins), which varies based on the history of the games which are not executed on the slot machine 1 (for example, games performed on the web and so-called stand alone games which are not connected to the network etc.), is read from the server 120 via the Internet 122. Then, the process is carried out which is appropriate to the FIG. 1D of the FIG. 13 read by the IC tag reader/writer 107 and the variable parameter information read from the server.

That is, in the case of a configuration wherein the server 120 stores the variable parameter information, the process is carried out which is appropriate to the player ID and the variable parameter information read from the server 120 by the parameter reading module (the CPU of the slot machine 1). Also, in the case of a configuration wherein the variable parameter information is stored in the IC tag 93 included in the FIG. 13, the process is carried out which is appropriate to the player ID and the variable parameter information read from the IC tag 93 by the parameter reading module (the IC tag reader/writer 107).

In this way, the process is carried out which is appropriate to the player ID and the variable parameter information which varies based on the games which are not executed on the slot machine 1 (the horse racing game). Therefore, in the event that the player causes the variable parameter information to change by performing the games which are not executed on the slot machine 1, the upper limit of the number of coins bet can be changed, in the slot machine 1, based on the variable parameter information changed in the game. Consequently, the history of the game not executed on the slot machine can be related to the game on the slot machine, thus increasing the interest value of the game.

Also, as the history of the game not executed on the slot machine is related to the game on the slot machine, it is possible to give people who do not normally play games on the slot machine the desire to do so.

Furthermore, as it is possible to use the variable parameter information used in the games not executed on the slot machine (for example, the horse racing game), in a wide variety of games etc., in the same way as being able to use it in games executed on the slot machine, it is possible to achieve game development.

Also, according to the slot machine 1 of this embodiment, it is possible to change the upper limit of the number of coins bet in accordance with the variable parameter information read from the server 120. Consequently, by reflecting the number of bets in the number of payouts, it is possible to arouse an appropriate gambling spirit, thereby further increasing the interest value of the game.

Also, according to the slot machine 1 of this embodiment, it is possible to cause the full color LED's disposed in the eye position of the FIG. 13 to illuminate in accordance with the variable parameter information read from the server 120. Consequently, it is possible to inform the player that the FIG. 13 is having an effect on the game on the slot machine 1.

In this embodiment, although a description has been given, as an operation in accordance with the variable parameter information, of a case in which the LED's disposed in the eye position of the FIG. 13 are illuminated, the operations in accordance with the variable parameter information are not limited to this example in the invention. For example, it is also acceptable to cause the figure to dance in accordance with the variable parameter information by providing the figure with a movable portion, a power source etc.

In this embodiment, although a description has been given of a case in which the process carried out based on the identification information and the variable parameter information is the process which changes the upper limit of the number of coins bet, the processes carried out based on the identification information and the variable parameter information are not limited to this example in the invention. For example, it is also acceptable to increase the reliability of the information effect, displayed in the lower liquid crystal display and the like, which informs of the possibility of a big bonus.

In this embodiment, although a description has been given of a case in which the variable parameter information includes the number of wins and each performance value, the variable parameter information of the invention is not particularly limited as long as it varies based on the history of the game not executed on the slot machine.

In this embodiment, although a description has been given of a case in which, after the play button has been depressed, the figure data (FIG. 1D) is read and the bet number is changed, the invention is not limited to this example, as it is also acceptable that the figure data is read and the bet number is changed before the play button is depressed.

### Second Embodiment

Next, a description will be given, with reference to FIGS. 29 to 36, of a slot machine according to a second embodiment. The same reference numerals are used for components which are the same as in the previous embodiment.

A slot machine 1 according to this embodiment has basically the same configuration as that in the previous embodiment wherein its characteristic feature lies in the point that compatibility information is generated based on variable parameter information read and a gaming machine ID peculiar to the slot machine 1. The variable parameter information, being information which differs depending on a figure, is information which changes according to a performance of a horse racing game, to be described hereafter. Also, the compatibility information refers to information which shows, according to a prescribed standard, a relationship between the gaming machine ID and the variable parameter information. Also, the gaming machine ID established for each slot machine 1 is stored in a ROM 51 (refer to FIG. 10). The ROM 51 functions as a gaming machine information storage module which stores the gaming machine ID established for each slot machine 1.

Each storage area of the ROM 51 in the slot machine 1 according to this embodiment is shown in FIG. 29. As shown in FIG. 29, a symbol lottery table 51A, which determines, based on a random number value, the symbols to be displayed in a stationary form in each of stationary display areas 211 to 213, 221 to 223, 231 to 233, 241 to 243 and 251 to 253 (refer to FIG. 3) of variable display windows 21 to 25, an award table 51B, which stores the winning combinations and awards for each symbol displayed in a stationary form in each stationary display area, a compatibility information generation table 51C (refer to FIG. 32), which determines the compatibility information to be generated based on the gaming machine ID and the variable parameter information, a compatibility information change table 51D (refer to FIG. 33), for changing the compatibility information based on temperature data, and a bet number upper limit change table 51E (refer to FIG. 36), which is used when determining the upper limit of the number of coins bet based on the variable parameter information and the random number value, are stored in the ROM 51.

Also, in the slot machine 1, the temperature data obtained by a temperature sensor included in a FIG. 13 is read from an IC tag 93 included in the FIG. 13. The temperature data corresponds to the ambient data of the embodiment.

The slot machine 1 changes the coin bet number upper limit based on the compatibility information and the temperature data. Consequently, the player is enabled to bet a large number of medals in the game performed on the slot machine 1 by using the figure.

At this point, a description will be given of the FIG. 13 according to this embodiment. FIGS. 30A and 30B are front views showing the figure according to this embodiment.

As shown in FIG. 30A, although the FIG. 13 according to this embodiment has the same basic configuration as that in the first embodiment, inside the FIG. 13, wiring is provided from an IC tag 93 towards the top of a figure main body 91, whereby the IC tag 93 is connected, by means of the wiring, to a temperature sensor 407 disposed in a rump portion of the figure main body 91 (refer to FIG. 30B). A temperature sensor detecting hole 407a is provided in the rump portion of the figure main body 91, enabling the temperature sensor 407 to detect the ambient temperature (refer to FIG. 30A).

FIG. 31 is a block diagram showing an internal configuration of the IC tag according to this embodiment.

The IC tag 93 according to this embodiment comprises a transceiver 401, a controller 402, a memory 403, an LED driver 404, and a sensor circuit 406. Also, an LED module 405 is connected to the LED driver 404, while the temperature sensor 407 is connected to the sensor circuit 406.

When the controller 402 receives various data (commands) via the transceiver 401, it stores the data received in the memory 403 in accordance with the commands and transmits the data stored in the memory 403 in accordance with the commands received via the transceiver 401.

The FIG. 1D and the like which constitutes a value peculiar to each of the FIG. 13 is stored in the memory 403. The slot machine 1 reads the FIG. 1D, then reads the variable parameter information corresponding to the FIG. 1D from a server 120. Then, the slot machine 1 changes the upper limit of the number of medals bet based on the variable parameter information. The FIG. 1D corresponds to identification information of the invention.

The LED driver 404 carries out display control for the LED module 405. The LED module 405 includes two full color LED's, wherein display control is carried out in accordance with the commands received via the transceiver. For example, red, yellow, green, blue etc. lights are emitted in accordance with the commands received via the transceiver.

The sensor circuit 406 converts the temperature detected by the temperature sensor 407 to temperature data of a prescribed format, and transmits it to the controller 402.

Although the slot machine 1 according to this embodiment is controlled, in the same way as that in the first embodiment, by the main process program shown in FIG. 14, a description of a start reception program carried out in S1 of the main process program will be given with reference to FIG. 32. FIG. 32 is a flowchart of the start reception program in the slot machine 1 according to this embodiment. As a lottery process (S2) and a bonus game process (S5) in the main process program are identical processes to those in the first embodiment, the description will be omitted.

The start reception process of this embodiment has basically the same process flow as the start reception process program (refer to FIG. 15) in the slot machine 1 according to the previously described first embodiment, wherein S110 to S160 in FIG. 32 correspond to S11 to S16 in FIG. 15.

As the S110 to S130 process is exactly the same as that in S11 to S13, the description will be omitted.

In S140, if it is determined that the FIG. 13 is mounted on an authentication unit 7 (S140: YES), in this embodiment, the temperature data detected by the temperature sensor 407 included in the FIG. 13 is read from the IC tag 93 built into the mounted FIG. 13 by an IC tag reader/writer 107. That is, a CPU 50 functions as an ambient data reading module.

To continue, a variable parameter information reading process is carried out in S160. The variable parameter information reading process in this case will be described in detail hereafter using FIG. 33. After the process in S160, the start reception process is finished and a shift is made to the lottery process (S2).

FIG. 33 is a flowchart showing a sub-routine of the variable parameter information reading process called up and executed in S160 of the flowchart shown in FIG. 32.

First, in S170, the FIG. 1D read (refer to S150) is transmitted to the server 120. The server 120 which receives the FIG. 1D extracts the variable parameter information (refer to FIG. 29) corresponding to the FIG. 1D from a hard disc drive, and transmits it to the slot machine 1 which receives the FIG. 1D.

Next, in S180, the variable parameter information is received from the server 120. The variable parameter information is the information extracted from the hard disc drive of the server 120 in response to the FIG. 1D transmitted to the server 120 in step S170. When this process is finished, the process is moved to S190. In S170 and S180, the CPU 50 of the slot machine 1 functions as a parameter reading module which reads the variable parameter information.

In S190, compatibility information is generated based on the gaming machine ID and the variable parameter information. In this process, the compatibility information is generated, with reference to the compatibility information generation table, based on the gaming machine ID stored in the ROM 51 and the received variable parameter information (refer to S180). At this time, the CPU 50 of the slot machine 1 functions as a compatibility information generating module which generates the compatibility information based on the gaming machine ID and the variable parameter information.

FIG. 34 shows one example of the compatibility information generation table.

A compatibility information generation table which differs according to the gaming machine ID is stored in the ROM 52 of the slot machine 1. In this embodiment, in a slot machine in which the last digit of the eight digit gaming machine ID is between 0 and 2 inclusive, the compatibility information generation table (slot machine 1a) is stored, in a slot machine in which it is between 3 and 5 inclusive, the compatibility information generation table (slot machine 1b) is stored, while in a slot machine 1 in which it is between 6 and 9 inclusive, the compatibility information generation table (slot machine 1c) is stored.

A stamina value is stored in the left hand column of the compatibility information generation table (slot machine 1a), while the compatibility information correlated to each stamina value is stored in the right hand column. Also, a speed value is stored in the left hand column of the compatibility information generation table (slot machine 1b), while the compatibility information correlated to each speed value is stored in the right hand column. Also, a will to win value is stored in the left hand column of the compatibility information generation table (slot machine 1c), while the compatibility information correlated to each will to win value is stored in the right hand column.

For example, in a case in which the performance value of the FIG. 13 owned by the player is “speed value 10, stamina value 25, will to win value 15”, in the event that the FIG. 13 is mounted on the slot machine 1 for which the last digit of the gaming machine ID is between 0 and 2 inclusive, reference is made to the compatibility information generation table (slot machine 1a) wherein, as the stamina value is 25, the compatibility information is “A”. Also, in the event that the FIG. 13 is mounted on the slot machine 1 for which the last digit of the gaming machine ID is between 3 and 5 inclusive, reference is made to the compatibility information generation table (slot machine 1b) wherein, as the speed value is 10, the compatibility information is “C”. Also, in the event that the FIG. 13 is mounted on the slot machine 1 for which the last digit of the gaming machine ID is between 6 and 9 inclusive, reference is made to the compatibility information generation table (slot machine 1c) wherein, as the will to win value is 15, the compatibility information is “B”. In this way, in the event that the slot machine 1 on which the FIG. 13 is mounted is different, it is possible to cause the compatibility information generated to differ.

In S200, the compatibility information is changed based on the temperature data. In this process, the compatibility information is changed, with reference to the compatibility information change table, based on the generated compatibility information (refer to S190) and the received temperature data (refer to S180).

FIG. 35 shows one example of the compatibility information change table.

A compatibility information change table which differs according to the gaming machine ID is stored in the ROM 51 of the slot machine 1. In this embodiment, in the slot machine 1 in which the last digit of the eight digit gaming machine ID is an even number, the compatibility information change table X is stored, while in the slot machine 1 in which it is an odd number, the compatibility information change table Y is stored.

A temperature data range is stored in the left hand column of the compatibility information change table, while the compatibility information before and after the compatibility information is changed for each temperature data range is shown in the right hand column.

In the compatibility information change table X, when the temperature data is 15 or less, that is, when the player is placed in an ambient temperature of 15° C. or less, in a case in which the compatibility information is “C”, it is changed to “A”, while in a case in which the compatibility information is “B”, it is changed to “A”. In a case in which the compatibility information is “A”, it remains unchanged at “A”.

Also, when the temperature data is greater than 15 but less than or equal to 20, in a case in which the compatibility information is “C”, it is changed to “B”, while in a case in which the compatibility information is “B”, it is changed to “A”. In a case in which the compatibility information is “A”, it remains unchanged at “A”.

Also, when the temperature data is greater than 20 but less than or equal to 25, in a case in which the compatibility information is “C”, it is changed to “B”. In a case in which the compatibility information is “A” or “B”, it remains unchanged.

Also, when the temperature data is greater than 25 but less than or equal to 30, the compatibility information is not changed.

Also, when the temperature data is greater than 30, in a case in which the compatibility information is “A”, it is changed to “C”, while in a case in which the compatibility information is “B”, it is changed to “C”. In a case in which the compatibility information is “C”, it remains unchanged at “C”.

Meanwhile, in the compatibility information change table Y, when the temperature data is 15 or less, that is, when the player is placed in an ambient temperature of 15° C. or less, in a case in which the compatibility information is “A”, it is changed to “C”, while in a case in which the compatibility information is “B”, it is changed to “C”. In a case in which the compatibility information is “C”, it remains unchanged at “C”.

Also, when the temperature data is greater than 15 but less than or equal to 20, the compatibility information is not changed.

Also, when the temperature data is greater than 20 but less than or equal to 25, in a case in which the compatibility information is “C”, it is changed to “B”. In a case in which the compatibility information is “A” or “B”, it remains unchanged.

Also, when the temperature data is greater than 25 but less than or equal to 30, in a case in which the compatibility information is “C”, it is changed to “B”, while in a case in which the compatibility information is “B”, it is changed to “A”. In a case in which the compatibility information is “A”, it remains unchanged at “A”.

Also, when the temperature data is greater than 30, in a case in which the compatibility information is “C”, it is changed to “A”, while in a case in which the compatibility information is “B”, it is changed to “A”. In a case in which the compatibility information is “A”, it remains unchanged at “A”.

In this way, while it is possible to change the compatibility information according to the ambient temperature of the slot machine 1 in which the FIG. 13 is transposed, at this time it is possible to cause the format of the compatibility information change to differ according to the compatibility information change table referred to.

Next, in S21, an operation command is transmitted to the FIG. 13. The operation command is one which includes an instruction which causes the full color LED's included in the LED module 405 of the FIG. 13 to be illuminated in response to the compatibility information (refer to S20). Specifically, the instruction is included whereby a red illumination is caused in a case in which the compatibility information is “C”, a yellow illumination in a case in which it is “B”, and a green illumination in a case in which it is “C”. When this process is finished, the variable parameter information reading process is finished. In S21, the CPU 50 of the slot machine 1 functions as a controller which controls in such a way as to cause the FIG. 13 to perform the operation corresponding to the compatibility information.

At this point, a description will be given of a base game process which is carried out in S3 of the main process (FIG. 14) in the embodiment.

In the base game process of this embodiment, in the same way as in the first embodiment, as shown in FIG. 18, first, in S31, the scrolling of each symbol is carried out in the variable display windows 21 to 25 based on the switch signals transmitted from the 1-LINE switch 60, the 5-LINES switch 61 and the 20-LINES switch 62, which are received in the start reception process (S1).

To continue, in S32, in the varying stage before the symbols stop in the variable display windows 21 to 25, as well as the upper limit of the number of coins bet being changed if the prescribed conditions are fulfilled, the bet number upper limit change process (described in the previous embodiment) is carried out wherein the change in the number of bets is received (refer to FIG. 19).

After that, the scrolling of each symbol in the variable display windows 21 to 25 is stopped (S33).

Furthermore, in S34, in accordance with the winning combinations of symbol displayed in a stationary form in each of the variable display windows 21 to 25 in S33, credits and the like equivalent to the awards determined based on the award table 51B in FIG. 12 are paid out. Then, after this payout process, the process returns to the main process program and proceeds to the evaluation process in S4.

Next, with regard to the bet number upper limit change process carried out in S32 in the slot machine 1 according to this embodiment, also as shown in FIG. 19, first, the random numbers are sampled in the range of 0 to 79 by the random number sampling circuit 56 in S41.

Next, it is determined whether or not the bet number upper limit has been changed in S42. If it is determined that the bet number upper limit has been changed, the process is moved to S43 while, if it is determined that the bet number upper limit has not been changed, the bet number upper limit change process is finished. The determining of whether or not the bet number upper limit has been changed is based on the random number value obtained in S41 and the bet number upper limit change table.

At this point, FIG. 36 shows one example of the bet number upper limit change table which determines the bet number upper limit in the embodiment. Three bet number upper limit change tables (bet number upper limit change table A, bet number upper limit change table B and bet number upper limit change table C) are stored in the ROM 51 in the slot machine 1.

The bet number upper limit change table A is the table which is referred to when the compatibility information is “A”, the bet number upper limit change table B is the table which is referred to when the compatibility information is “B”, and the bet number upper limit change table C is the table which is referred to when the compatibility information is “C”.

A random number extraction value is stored in the left hand column of the bet number upper limit change table, while the bet number upper limit value corresponding to each number of wins is stored in the column to the right, correlated to each random number extraction value. The number of wins refers to a number of wins in a horse racing game to be described hereafter, and is included in the variable parameter information received in S18.

The bet number upper limit change table is a look-up table wherein, in the bet number upper limit change table A, for example, in a case in which the number of wins is 0 to 9 inclusive, in the event that the random number extraction value is between 0 and 31 inclusive, the bet number upper limit is changed to 7. In the event that the random number extraction value is between 32 and 79 inclusive, the bet number upper limit remains unchanged at 5. In a case in which the figure is not used, the number of wins is 0.

Also, for example, in a case in which the number of wins is 10 to 19 inclusive, in the event that the random number extraction value is between 0 and 31 inclusive, the bet number upper limit is determined to be 10, in the event that the random number extraction value is between 32 and 47 inclusive, the bet number upper limit is determined to be 7. In the event that the random number extraction value is between 33 and 79 inclusive, the bet number upper limit remains unchanged at 5.

Also, for example, in a case in which the number of wins is 20 to 29 inclusive, in the event that the random number extraction value is between 0 and 31 inclusive, the bet number upper limit is determined to be 20, in the event that the random number extraction value is between 32 and 47 inclusive, the bet number upper limit is determined to be 10, in the event that the random number extraction value is between 48 and 63 inclusive, the bet number upper limit is determined to be 7. In the event that the random number extraction value is between 64 and 79 inclusive, the bet number upper limit remains unchanged at 5.

Also, for example, in a case in which the number of wins is 30 or more, in the event that the random number extraction value is between 0 and 47 inclusive, the bet number upper limit is determined to be 20, in the event that the random number extraction value is between 48 and 63 inclusive, the bet number upper limit is determined to be 10, in the event that the random number extraction value is between 64 and 79 inclusive, the bet number upper limit is determined to be 7.

In this way, the larger the number of wins indicated by the variable parameter information, the greater the possibility that the bet number upper limit is changed to a high level.

Also, although the random number extraction value and the number of wins are correlated and stored in the same way in the bet number upper limit change table B and the bet number upper limit change table C, the bet number upper limit in each column of the bet number upper limit change table B is set lower than the bet number upper limit in the corresponding column of the bet number upper limit change table A. Furthermore, the bet number upper limit in each column of the bet number upper limit change table C is set lower than the bet number upper limit in the corresponding column of the bet number upper limit change table B.

In this way, as the bet number upper limit change table referred to differs, the assigned bet number upper limit can be caused to differ in accordance with the compatibility information.

If it is determined that the bet number upper limit has been changed (S42: YES), a bet number change signal is received (S43). In this process, in response to the changed bet number upper limit, as well as enabling the operation of the BET 7 PER LINE button 36, the BET 10 PER LINE button 37 and the BET 20 PER LINE button 38, an effect is started to indicate that the bet number can be changed. When this process is finished, the process is moved to S44.

Also, for example, in S42, if it is determined that the bet number upper limit has been changed to 20, in this embodiment as well, in the same way as in the previous embodiment, a display saying “YOU CAN BET 20 PER LINE!!” is displayed in the lower liquid crystal display, as shown in FIGS. 21.

In S44, it is determined whether or not there has been a signal to the effect that the number of bets is to be changed. In this process, it is determined whether or not one of the bet buttons for which input is possible has been operated. If it is determined that there has been no operation, it is determined whether or not a prescribed time has elapsed (S45). If it is determined that the prescribed time has not elapsed, the process is returned to S44, while, if the prescribed time has elapsed, the bet number upper limit change process is finished.

Meanwhile, if it is determined that there has been a signal to the effect that the number of bets is to be changed (S44: YES), the bet number is changed to the bet number corresponding to the bet button depressed (S46). After that, the bet number upper limit change process is finished. In the bet number upper limit change process shown in FIG. 19, the CPU 50 functions as a process execution module which executes the process appropriate to the FIG. 1D and the variable parameter information.

Heretofore, although a description of the first embodiment and the second embodiment according to the invention has been given, only specific examples have been illustrated, the invention is not particularly limited to these, as appropriate design change of the specific configuration of each module and the like is possible. Also, the advantages mentioned in the embodiments of the invention are merely examples of the most preferable advantages arising from the invention, and the advantages according to the invention are not limited to those mentioned in the embodiments of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A server communicating with a gaming machine comprising:
a game execution module which executes a game on the web;
an identification information storage module which stores identification information of a readable object;
a parameter information storage module which stores variable parameter information, correlating it to the identification information;
an update module which updates the variable parameter information stored in the parameter information storage module in accordance with a result of a game executed by the game execution module; and
a transmitting module which transmits the variable parameter information corresponding to the identification information of the readable object received from the gaming machine to the gaming machine.

2. A server communicating with a gaming machine according to claim 1, wherein
the variable parameter information transmitted to the gaming machine from the transmitting module is used as information for the purpose of generating compatibility information correlated to the identification information of the readable object received from the gaming machine.

3. A gaming machine capable of executing a game using a readable object, comprising:
an identification information reading module which reads identification information stored in the readable object;
a game execution module which executes a game;
a parameter reading module which reads variable parameter information of the readable object, which varies based on the history of a game which has different contents from the game executed by the game execution module, and which is not executed on the gaming machine; and
a process execution module which executes a process appropriate to the identification information read by the identification information reading module and the variable parameter information read by the parameter reading module.

4. A gaming machine according to claim 3, comprising an input device which enables an input of a number of playing media bet in one game, wherein
the process execution module changes an upper limit of the number of playing media bet which can be input by the input device, in accordance with the variable parameter information read by the parameter reading module.

5. A gaming machine according to claim 3, comprising a controller which controls in such a way as to cause the readable object to operate in accordance with the variable parameter information read by the parameter reading module.

6. A gaming machine according to claim 3, further comprising:
a gaming machine information storage module which stores gaming machine information established for each gaming machine; and
a compatibility information generating module, which generates compatibility information showing, according to a prescribed standard, a relationship between the gaming machine information stored in the gaming machine information storage module and the variable parameter information read by the parameter reading module, wherein
the process execution module executes a process appropriate to the identification information read by the identification information reading module and the compatibility information generated by the compatibility information generating module.

7. A gaming machine according to claim 6, comprising an ambient data reading module which reads ambient data related to an ambient physical phenomenon detected by a sensor provided on the readable object, wherein
the process execution module executes a process appropriate to the identification information read by the identification information reading module, the compatibility information generated by the compatibility information generating module, and the ambient data read by the ambient data reading module.

8. A gaming machine according to claim 6, comprising a controller which controls in such a way as to cause the readable object to operate in accordance with the compatibility information generated by the compatibility information generating module.

9. A gaming machine according to claim 8, wherein the controller carries out display control on a display module included in the readable object in accordance with the compatibility information generated by the compatibility information generating module.
